(19) United States
(12) Patent Application Publication
(10) Pub. No.: US 2023/0086870 A1
(43) Pub. Date: Mar. 23, 2023

(54) SILICONE-ACRYLATE POLYMERS, COPOLYMERS, AND RELATED METHODS AND COMPOSITIONS

(71) Applicants: DOW SILICONES CORPORATION, Midland, MI (US); DOW GLOBAL TECHNOLOGIES LLC, Midland, MI (US)

(72) Inventors: Erin B. VOGEL, Midland, MI (US); Ray E. DRUMRIGHT, Midland, MI (US); Wesley SATTLER, Midland, MI (US); Tzu-Chi KUO, Midland, MI (US); Jodi M. MECCA, Midland, MI (US); Kangsang LEE, Midland, MI (US)

(21) Appl. No.: 17/793,840

(22) PCT Filed: Jan. 21, 2021
(86) PCT No.: PCT/US2021/014292

§ 371 Date: Jul. 19, 2022

Related U.S. Application Data
(60) Provisional application No. 62/964,439, filed on Jan. 22, 2020.

(51) Int. Cl. C08F 130/08; C09D 143/04; C09D 201/10; C09J 143/04; C09J 201/10; C08F 220/18; C08F 30/08

(52) U.S. Cl. CPC C08F 130/08; C09D 143/04; C09D 201/10; C09J 143/04; C09J 201/10; C08F 220/18; C08F 30/08

(57) ABSTRACT

A liquid composition is disclosed. The liquid composition comprises a silicone-acrylate polymer. The silicone-acrylate polymer comprises acrylate-derived monomeric units comprising siloxane moieties, optionally epoxide-functional moieties, and optionally, hydrocarbyl moieties. A method of preparing the silicone-acrylate polymer and the liquid composition is also disclosed.

### CROSS REFERENCE TO RELATED APPLICATIONS

This application claims priority to and all advantages of U.S. Provisional Patent Application No. 62/964,439 filed on 22 Jan. 2020, the content of which is incorporated herein by reference.

### FIELD OF THE INVENTION

The present disclosure generally relates to siloxane-functionalized polymers and, more specifically, to liquid compositions comprising a silicone-functionalized acrylate polymer, and compounds and methods for preparing the same.

### DESCRIPTION OF THE RELATED ART

Silicones are polymeric materials used in numerous commercial applications, primarily due to significant advantages they possess over their carbon-based analogues. More precisely called polymerized siloxanes or polysiloxanes, silicones have an inorganic silicon-oxygen backbone chain ( . . . —Si—O—Si—O—Si—O— . . . ) with organic side groups attached to the silicon atoms.

Organic side groups may be used to link two or more of these backbones together. By varying the —Si—O— chain lengths, side groups, and crosslinking, silicones can be synthesized with a wide variety of properties and compositions, with silicone networks varying in consistency from liquid to gel to rubber to hard plastic.

Silicone and siloxane-based materials are known in the art and are utilized in myriad end use applications and environments. The most common silicone materials are based on the linear organopolysiloxane polydimethylsiloxane (PDMS), a silicone oil. Such organopolysiloxanes are utilized in numerous industrial, home care, and personal care formulations. The second largest group of silicone materials is based on silicone resins, which are formed with branched and cage-like oligosiloxanes. Unfortunately, the use of siloxane-based materials in certain applications that may benefit from particular inherent attributes of organopolysiloxanes (e.g. low-loss and stable optical transmission, thermal and oxidative stability, etc.) remains limited due to weak mechanical properties of conventional silicone networks, which may manifest in materials with poor or unsuitable characteristics such as low tensile strength, low tear strength, etc. Moreover, conventional silicone networks and carbon-based polymers are often incompatible and/or possess antagonistic properties with respect to one another

### BRIEF SUMMARY

A liquid composition comprising a silicone-acrylate polymer is provided. The silicone-acrylate polymer has the following general average unit formula (I):

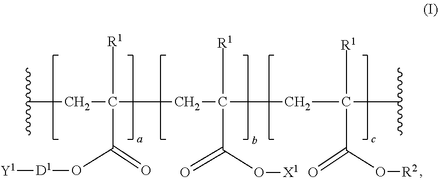

wherein: each Y¹ is an independently selected siloxane moiety; each D¹ is a divalent linking group; each X¹ is an independently selected epoxide-functional moiety; each R¹ is independently selected from H and CH₃; each R² is independently a substituted or unsubstituted hydrocarbyl group or H; subscript a 1; subscript b 0; subscript c≥0, with the proviso that a+b+c≥2; and units indicated by subscripts a, b, and c may be in any order in the silicone-acrylate polymer. The liquid composition optionally comprises a carrier vehicle, and has a total amount of volatile organic compounds (VOCs) in a range of from 0 to 25 wt. % based on the total weight of the liquid composition.

A method of preparing the liquid composition (the “preparation method”) is also provided. The preparation method comprises combining the silicone-acrylate polymer and optionally the carrier vehicle to give the liquid composition.

A film formed with the liquid composition is also provided.

### DETAILED DESCRIPTION OF THE INVENTION

A liquid composition comprising a silicone-acrylate polymer is provided. The liquid composition may be utilized in diverse end-use applications, including as a component in a functional composition, a precursor for preparing copolymers or other materials, etc., in or as a coating composition, etc. By “liquid,” it is meant that the liquid composition is flowable at 25° C., and that the liquid composition has a viscosity that can be measured at 25° C. In specific embodiments, the liquid composition has a viscosity that can be measured at 25° C. with an Anton Paar MCR-302 rheometer using a 50 mm cone and plate geometry (forward sweep, low to high shear) at shear rates of from 50 to 500 s^{-1.}

The silicone-acrylate polymer generally comprises two or more monomeric units derived from acryloxy-functional monomers, which may be the same as or different from one another, e.g. the silicone-acrylate polymer may be a homopolymer, a copolymer, a terpolymer, etc. The silicone-acrylate polymer may be characterized, defined, or otherwise referred to as an acrylate or acrylic polymer or copolymer. However, as described below and illustrated by the examples herein, the silicone-acrylate polymer may comprise functionality unrelated to acrylate/acryloxy-functional groups or monomers (e.g. other polymeric moieties, end-capping groups, etc.), but nonetheless may be simply described or referred to as an acrylate polymer, as will be understood by those of skill in the art.

The silicone-acrylate polymer has the following general average unit formula (I):

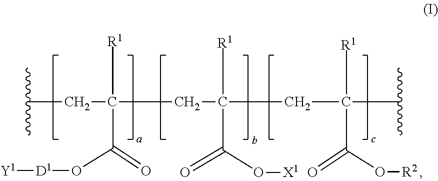

wherein: each Y¹ is an independently selected siloxane moiety; each D¹ is a divalent linking group; each X¹ is an independently selected epoxide-functional moiety; each R¹ is independently selected from H and CH₃; each R² is independently a substituted or unsubstituted hydrocarbyl group or H; subscript a≥1; subscript b≥0; subscript c≥0, with the proviso that a+b+c≥2; and units indicated by subscripts a, b, and c may be in any order in the silicone-acrylate polymer.

With regard to formula (I), as introduce above, Y¹ represents a siloxane moiety. In general, the siloxane moiety Y¹ comprises a siloxane and is otherwise not particularly limited. As understood in the art, siloxanes comprise an inorganic silicon-oxygen-silicon group (i.e., —Si—O—Si—), with organosilicon and/or organic side groups attached to the silicon atoms. As such, siloxanes may be represented by the general formula ([R_{f}SiO_{(4-f)}/2]e)_{g}(R)_{3-g}Si—, where subscript f is independently selected from 1, 2, and 3 in each moiety indicated by subscript e, subscript e is at least 1, subscript g is 1, 2, or 3, and each R is independently selected from hydrocarbyl groups, alkoxy and/or aryloxy groups, and siloxy groups.

Hydrocarbyl groups suitable for R include monovalent hydrocarbon moieties, as well as derivatives and modifications thereof, which may independently be substituted or unsubstituted, linear, branched, cyclic, or combinations thereof, and saturated or unsaturated. With regard to such hydrocarbyl groups, the term “unsubstituted” describes hydrocarbon moieties composed of carbon and hydrogen atoms, i.e., without heteroatom substituents. The term “substituted” describes hydrocarbon moieties where either at least one hydrogen atom is replaced with an atom or group other than hydrogen (e.g. a halogen atom, an alkoxy group, an amine group, etc.) (i.e., as a pendant or terminal substituent), a carbon atom within a chain/backbone of the hydrocarbon is replaced with an atom other than carbon (e.g. a heteroatom, such as oxygen, sulfur, nitrogen, etc.) (i.e., as a part of the chain/backbone), or both. As such, suitable hydrocarbyl groups may comprise, or be, a hydrocarbon moiety having one or more substituents in and/or on (i.e., appended to and/or integral with) a carbon chain/backbone thereof, such that the hydrocarbon moiety may comprise, or be, an ether, an ester, etc. Linear and branched hydrocarbyl groups may independently be saturated or unsaturated and, when unsaturated, may be conjugated or nonconjugated. Cyclic hydrocarbyl groups may independently be monocyclic or polycyclic, and encompass cycloalkyl groups, aryl groups, and heterocycles, which may be aromatic, saturated and nonaromatic and/or non-conjugated, etc. Examples of combinations of linear and cyclic hydrocarbyl groups include alkaryl groups, aralkyl groups, etc. General examples of hydrocarbon moieties suitably for use in or as the hydrocarbyl group include alkyl groups, aryl groups, alkenyl groups, alkynyl groups, halocarbon groups, and the like, as well as derivatives, modifications, and combinations thereof. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, octyl (including ethylhexyl) and the like (i.e., other linear or branched saturated hydrocarbon groups. Examples of aryl groups include phenyl, tolyl, xylyl, naphthyl, benzyl, dimethyl phenyl, and the like, as well as derivatives and modifications thereof, which may overlap with alkaryl groups (e.g. benzyl) and aralkyl groups (e.g. tolyl, dimethyl phenyl, etc.). Examples of alkenyl groups include vinyl, allyl, propenyl, isopropenyl, butenyl, isobutenyl, pentenyl, heptenyl, hexenyl, cyclohexenyl groups, and the like, as well as derivatives and modifications thereof. General examples of halocarbon groups include halogenated derivatives of the hydrocarbon moieties above, such as halogenated alkyl groups (e.g. any of the alkyl groups described above, where one or more hydrogen atoms is replaced with a halogen atom such as F or Cl), aryl groups (e.g. any of the aryl groups described above, where one or more hydrogen atoms is replaced with a halogen atom such as F or Cl), and combinations thereof. Examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, 3,4-difluoro-5-methylcycloheptyl, chloromethyl, chloropropyl, 2-dichlorocyclopropyl, 2,3-dichlorocyclopentyl, and the like, as well as derivatives and modifications thereof. Examples of halogenated aryl groups include chlorobenzyl, pentafluorophenyl, fluorobenzyl groups, and the like, as well as derivatives and modifications thereof.

Alkoxy and aryloxy groups suitable for R include those having the general formula —ORⁱ, where Rⁱ is one of the hydrocarbyl groups set forth above with respect to R. Examples of alkoxy groups include methoxy, ethoxy, propoxy, butoxy, benzyloxy, and the like, as well as derivatives and modifications thereof. Examples of aryloxy groups include phenoxy, tolyloxy, pentafluorophenoxy, and the like, as well as derivatives and modifications thereof.

Examples of suitable siloxy groups suitable for R include [M], [D], [T], and [Q] units, which, as understood in the art, each represent structural units of individual functionality present in siloxanes, such as organosiloxanes and organopolysiloxanes. More specifically, [M] represents a monofunctional unit of general formula Rⁱⁱ₃SiO_{1/2}; [D] represents a difunctional unit of general formula Rⁱⁱ₂SiO_{2/2}; [T] represents a trifunctional unit of general formula RⁱⁱSiO_{3/2}; and [Q]represents a tetrafunctional unit of general formula SiO₄/2, as shown by the general structural moieties below:

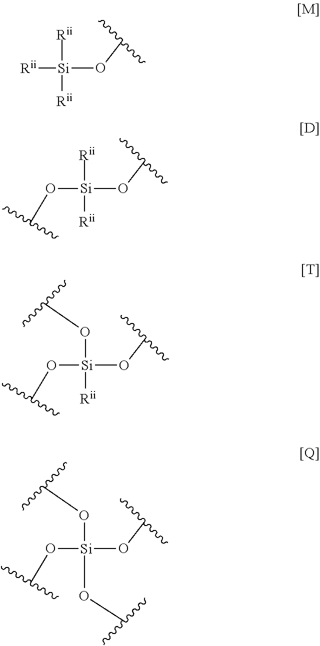

In these general structural moieties, each Rⁱⁱ is independently a monovalent or polyvalent substituent. As understood in the art, specific substituents suitable for each Rⁱⁱ are not limited, and may be monoatomic or polyatomic, organic or inorganic, linear or branched, substituted or unsubstituted, aromatic, aliphatic, saturated or unsaturated, and combinations thereof. Typically, each Rⁱⁱ is independently selected from hydrocarbyl groups, alkoxy and/or aryloxy groups, and siloxy groups. As such, each Rⁱⁱ may independently be a hydrocarbyl group of formula —Rⁱ or an alkoxy or aryloxy group of formula —ORⁱ, where Rⁱ is as defined above (e.g. including any of the hydrocarbyl groups set forth above with respect to R), or a siloxy group represented by any one, or combination, of [M], [D], [T], and/or [Q] units described above.

The siloxane moiety Y¹ may be linear, branched, or combinations thereof, e.g. based on the number and arrangement of [M], [D], [T], and/or [Q] siloxy units present therein. When branched, the siloxane moiety Y¹ may minimally branched or, alternatively, may be hyperbranched and/or dendritic.

In certain embodiments, the siloxane moiety Y¹ is a branched siloxane moiety having the general formula —Si(R³)₃, wherein at least one R³ is —OSi(R⁵)₃ and each other R³ is independently selected from R⁴ and —OSi(R⁵)₃. In such embodiments, each R⁵ is independently selected from R⁴, —OSi(R⁶)₃, and -[-D²-SiR⁴₂]ₘOSiR⁴₃; where each R⁶ is independently selected from R⁴, —OSi(R⁷)₃, and -[-D²-SiR⁴₂]ₘOSiR⁴₃; where each R⁷ is independently selected from R⁴ and -[-D²-SiR⁴₂]ₘOSiR⁴₃. In each selection, R⁴ is an independently selected substituted or unsubstituted hydrocarbyl group, such as any of those described above with respect to R, D² is a divalent linking group individually selected in each moiety indicated by subscript m, and each subscript m is individually selected such that 0≤m≤100 (i.e., in each selection where applicable).

In such branched siloxane moieties of Y¹, each divalent linking group D² is typically selected from oxygen (i.e., —O—) and divalent hydrocarbon groups. Examples of such hydrocarbon groups include divalent forms of the hydrocarbyl and hydrocarbon groups described above, such as any of those set forth above with respect to R. As such, it will be appreciated that suitable hydrocarbon groups for the divalent linking group D² may be substituted or unsubstituted, and linear, branched, and/or cyclic. Typically, however, when divalent linking group D² is a divalent hydrocarbon group, D² is selected from unsubstituted linear alkylene groups, such as ethylene, propylene, butylene, etc.

In certain embodiments, each divalent linking group D² is oxygen (i.e., —O—), such that each R⁵ is independently selected from R⁴, —OSi(R⁶)₃, and —[OSiR⁴₂]ₘOSiR⁴₃, each R⁶ is independently selected from R⁴, —OSi(R⁷)₃, and —[OSiR⁴₂]ₘOSiR⁴₃, and each R⁷ is independently selected from R⁴ and —[OSiR⁴₂]ₘOSiR⁴₃, where each R⁴ is as defined and described above and each subscript m is as defined above and described below.

As introduced above, each R³ is selected from R⁴ and —OSi(R⁵)₃, with the proviso that at least one R³ is of formula —OSi(R⁵)₃. In certain embodiments, at least two R³ are of formula —OSi(R⁵)₃. In specific embodiments, each R³ is of formula —OSi(R⁵)₃. It will be appreciated that a greater number of R³ being —OSi(R⁵)₃ increases the level of branching in the siloxane moiety Y¹. For example, when each R³ is —OSi(R⁵)₃, the silicon atom to which each R³ is bonded is a [T] siloxy unit. Alternatively, when but two R³ are of formula —OSi(R⁵)₃, the silicon atom to which each R³ is bonded is a [D] siloxy unit. Moreover, when any R³ is of formula —OSi(R⁵)₃, where at least one of those R⁵ is of formula —OSi(R⁶)₃, further siloxane bonds and branching are present in the siloxane moiety Y¹. This is further the case when any R⁶ is of formula —OSi(R⁷)₃. As such, it will be understood by those of skill in the art that each subsequent R⁵⁺ⁿ moiety in the siloxane moiety Y¹ can impart a further generation of branching, depending on the particular selections thereof. For example, at least one R⁵ can be of formula —OSi(R⁶)₃, where at least one of those R⁶ can be of formula —OSi(R⁷)₃. Thus, depending on a selection of each substituent, further branching attributable to [T] and/or [Q] siloxy units may be present in the siloxane moiety Y¹ (i.e., beyond those of other substituents/moieties described above).

Each R⁵ is independently selected from R⁴, —OSi(R⁶)₃, and -[-D²-SiR⁴₂]ₘOSiR⁴₃, where each R⁴, D², and R⁶ is as defined and described above and each subscript m is as defined above and described below. For example, when D² is oxygen (i.e., —O—), R⁵ is selected from R⁴, —OSi(R⁶)₃, and —[OSiR⁴₂]ₘOSiR⁴₃, where 0≤m≤100. Depending on a selection of R⁵ and R⁶, further branching can be present in the siloxane moiety Y¹. For example, when each R⁵ is R⁴, then each —OSi(R⁵)₃ moiety (i.e., each R³ of formula —OSi(R⁵)₃) is a terminal [M] siloxy unit. Said differently, when each R³ is —OSi(R⁵)₃ and each R⁵ is R⁴, then each R³ can be written as —OSiR⁴₃ (i.e., an [M] siloxy unit). In such embodiments, the siloxane moiety Y¹ includes a [T] siloxy unit bonded to group D¹ in formula (I), which [T] siloxy unit is capped by three [M] siloxy units. Moreover, when R⁵ is of formula -[-D²-SiR⁴₂]ₘOSiR⁴₃, and D² is oxygen (i.e., —O—), the siloxane moiety Y¹ includes optional [D] siloxy units (i.e., those siloxy units in each moiety indicated by subscript m) as well as an [M] siloxy unit (i.e., represented by OSiR⁴₃). As such, when each R³ is of formula —OSi(R⁵)₃, R⁵ is of formula -[-D²-SiR⁴₂]ₘOSiR⁴₃, and each D² is oxygen (i.e., —O—), then each R³ includes a [Q] siloxy unit. More specifically, in such embodiments, each R³ is of formula —OSi([OSiR⁴₂]ₘOSiR⁴₃)₃, such that when each subscript m is 0, each R³ is a [Q] siloxy unit endcapped with three [M] siloxy units. Likewise, when subscript m is greater than 0, each R³ includes a linear moiety (i.e., a diorganosiloxane moiety) with a degree of polymerization being attributable to subscript m.

As set forth above, each R⁵ can also be of formula —OSi(R⁶)₃. In embodiments where one or more R⁵ is of formula —OSi(R⁶)₃, further branching can be present in the siloxane moiety Y¹ depending a selection of R⁶. More specifically, each R⁶ is selected from R⁴, —OSi(R⁷)₃, and -[-D²-SiR⁴₂]ₘOSiR⁴₃, where each R⁷ is selected from R⁴ and -[-D²-SiR⁴₂]ₘOSiR⁴₃, and where each subscript m is defined above. For examples, in some embodiments, each D² is oxygen (i.e., —O—), such that each R⁶ is selected from R⁴, —OSi(R⁷)₃, and —[OSiR⁴₂]ₘOSiR⁴₃, where each R⁷ is selected from R⁴ and —[OSiR⁴₂]ₘOSiR⁴₃, and where each subscript m is as defined above and described below.

As introduced above, with respect to the branched siloxane moiety of Y¹, subscript m is from (and including) 0 to 100, alternatively from 0 to 80, alternatively from 0 to 60, alternatively from 0 to 40, alternatively from 0 to 20, alternatively from 0 to 19, alternatively from 0 to 18, alternatively from 0 to 17, alternatively from 0 to 16, alternatively from 0 to 15, alternatively from 0 to 14, alternatively from 0 to 13, alternatively from 0 to 12, alternatively from 0 to 11, alternatively from 0 to 10, alternatively from 0 to 9, alternatively from 0 to 8, alternatively from 0 to 7, alternatively from 0 to 6, alternatively from 0 to 5, alternatively from 0 to 4, alternatively from 0 to 3, alternatively from 0 to 2, alternatively from 0 to 1, alternatively is 0. In certain embodiments, each subscript m is 0, such that the siloxane moiety Y¹ is free from [D] siloxy units.

Importantly, each of R³, R⁴, R⁵, R⁶, and R⁷ are independently selected. As such, the descriptions above relating to each of these substituents is not meant to mean or imply that each substituent is the same. Rather, any description above relating to R⁵, for example, may relate to only one R⁵ or any number of R⁵ in the siloxane moiety Y¹, and so on. In addition, different selections of R³, R⁴, R⁵, R⁶, and R⁷ can result in the same structures. For example, if a particular R³ is —OSi(R⁵)₃, wherein each R⁵ is —OSi(R⁶)₃, where each R⁶ is R⁴, then that particular R³ can be written as —OSi(OSiR⁴₃)₃. Similarly, if a specific R³ is —OSi(R⁵)₃, wherein each R⁵ is -[-D²-SiR⁴₂]ₘOSiR⁴₃, where subscript m is 0, that specific R³ can be written as —OSi(OSiR⁴₃)₃. As shown, these particular selections result in the same final structure for R³, based on different selections for R⁵. To that end, any proviso of limitation on final structure of the siloxane moiety Y¹ is to be considered met by an alternative selection that results in the same structure required in the proviso.

In certain embodiments, each R⁴ is an independently selected alkyl group. In some such embodiments, each R⁴ is an independently selected alkyl group having from 1 to 10, alternatively from 1 to 8, alternatively from 1 to 6, alternatively from 1 to 4, alternatively from 1 to 3, alternatively from 1 to 2 carbon atom(s).

In particular embodiments, each subscript m is 0, and each R⁴ is methyl, and the siloxane moiety Y¹ has one of the following structures (i)-(iv):

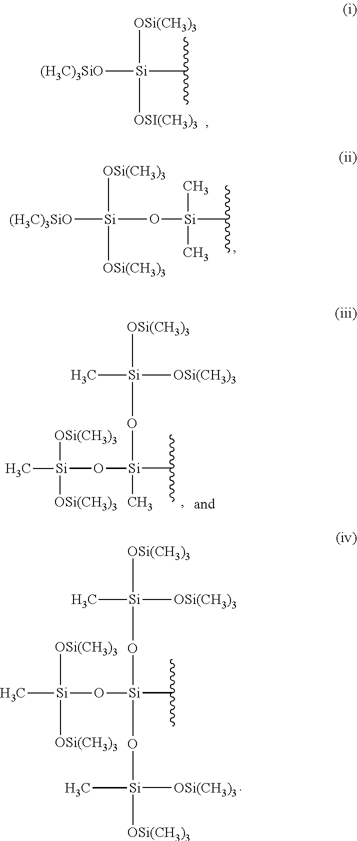

In certain embodiments, the siloxane moiety Y¹ is a linear siloxane moiety having the following general formula:

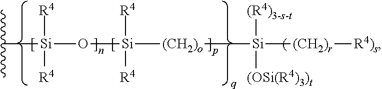

where 0≤n≤100, subscript o is from 2 to 6, subscript p is 0 or 1, subscript q is 0 or 1, subscript r is from 0 to 9, subscript s is 0 or 1, subscript t is 0 or 2, s+t>0, and each R⁴ is an independently selected and as defined above. For example, in some such embodiments, each R⁴ is methyl, such that the siloxane moiety Y¹ is a linear siloxane moiety having the following general formula:

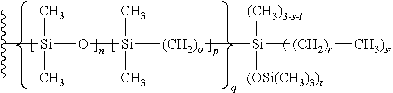

where subscripts n, o, p, q, r, s, and t are as defined above. However, it is to be appreciated that any R⁴ may be selected from other hydrocarbyl groups, such as those described above.

In general, with respect to the linear siloxane moiety of Y¹, subscript n is equivalent to subscript m above, and thus represents a value of from (and including) 0 to 100. Likewise, subscript n may be from 0 to 80, such as from 0 to 60, alternatively from 0 to 40, alternatively from 0 to 20, alternatively from 0 to 19, alternatively from 0 to 18, alternatively from 0 to 17, alternatively from 0 to 16, alternatively from 0 to 15, alternatively from 0 to 14, alternatively from 0 to 13, alternatively from 0 to 12, alternatively from 0 to 11, alternatively from 0 to 10, alternatively from 0 to 9, alternatively from 0 to 8, alternatively from 0 to 7, alternatively from 0 to 6, alternatively from 0 to 5, alternatively from 0 to 4, alternatively from 0 to 3, alternatively from 0 to 2, alternatively from 0 to 1, alternatively is 0. In certain embodiments, subscript n is 0, such that the linear siloxane moiety Y¹ is free from [D] siloxy units in the segment indicated by subscript q (i.e., when q is 1). In other embodiments, however, subscript q is 1 and subscript n is 1, such that the segment of the linear siloxane moiety Y¹ indicated by subscript q comprises at least one [D] siloxy units. For example, in such embodiments, subscript n is from 1 to 100, such as from 5 to 100, alternatively from 5 to 90, alternatively from 5 to 80, alternatively from 5 to 70, alternatively from 7 to 70, such that the segment of the linear siloxane moiety Y¹ indicated by subscript q comprises a number of [D] siloxy units in one of those ranges.

Subscript o is from 2 to 6, such that the segment indicated by subscript o is a C₂-C₆ alkylene group, such as an ethylene, propylene, butylene, pentylene, or hexylene group. Likewise, subscript r is from 0 to 9, and the segment indicated by subscript r, when r is 1, is a C₁-C₉ alkylene group, such as any of those described above with respect to subscript 0, or a heptylene, octylene, or nonylene group.

Subscripts s and t represent the substitution of the terminal silicon atom of the linear siloxane moiety Y¹. In general, at least one of subscripts s and t is >0 (i.e., s+t>0). For example, in certain embodiments, subscript s is 1 and subscript t is 0. In other embodiments, subscript s is 0 and subscript t is 2. In particular embodiments, the general formula of the linear siloxane moiety Y¹ above is subject to the proviso that subscript t is 0 when subscript s is 1, and subscript t is 2 when subscript s is 0.

In some embodiments, subscript q is 0, and subscript t is 2, such that Y¹ is an MD'M siloxane of general formula

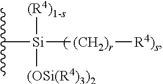

where each R⁴, subscript r, and subscript s, is as defined above. One of skill in the art will recognize that, in such embodiments, different selections within the preceding general formula will achieve the same particular structure of the linear siloxane moiety Y¹. In particular, when subscript r is 0, the linear siloxane moiety Y¹ would be an MD'M siloxane of formula —Si(OSiR⁴₃)₂(R⁴) independent of the selection of subscript s as 0 or 1. For example, in certain embodiments, subscript q is 0, subscript r is 0, subscript t is 2, and each R⁴ is methyl, such that Y¹ is an MD'M siloxane of formula:

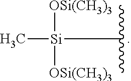

In particular embodiments, subscript p is 0, subscript q is 1, subscript s is 1, subscript t is 0, and each R⁴ is methyl, such that Y¹ has the formula:

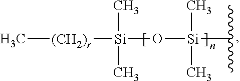

where subscripts n and r are as defined and described above. In some such embodiments, subscript r is 4 or 6. In these or other such embodiments, subscript n is ≥1, such as from 5 to 70.

In certain embodiments, subscript q is 1, subscript p is 1, and subscript n is 1, such that Y¹ has the formula:

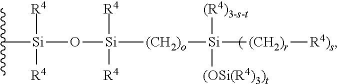

where each R⁴ and subscripts o, r, s, and t are as defined above. For example, in certain such embodiments, subscript o is 2, subscript s is 0, subscript t is 2, and each R⁴ is methyl. In other such embodiments, subscript o is 2, subscript s is 1, subscript r is 0, subscript t is 2, and each R⁴ is methyl. In both of the preceding embodiments, Y¹ has the formula:

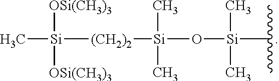

With further regard to formula (I), as introduced above, each D¹ is an independently selected divalent linking group. Divalent linking groups suitable for D¹ are not particularly limited. Typically, the divalent linking group D¹ is selected from divalent hydrocarbon groups. Examples of such hydrocarbon groups include divalent forms of the hydrocarbyl and hydrocarbon groups described above, such as any of those set forth above with respect to R. As such, it will be appreciated that suitable hydrocarbon groups for the divalent linking group D¹ may be substituted or unsubstituted, and linear, branched, and/or cyclic.

In some embodiments, divalent linking group D¹ comprises, alternatively is a linear or branched hydrocarbon moiety, such as a substituted or unsubstituted alkyl group, alkylene group, etc. For example, in certain embodiments, divalent linking group D¹ comprises, alternatively is, a C₁-C₁₈ hydrocarbon moiety, such as a linear hydrocarbon moiety having the formula —(CH₂)_{d}—, where subscript d is from 1 to 18. In some such embodiments, subscript d is from 1 to 16, such as from 1 to 12, alternatively from 1 to 10, alternatively from 1 to 8, alternatively from 1 to 6, alternatively from 2 to 6, alternatively from 2 to 4. In particular embodiments, subscript d is 3, such that divalent linking group D¹ comprises, alternatively is, a propylene (i.e., a chain of 3 carbon atoms). As will be appreciated by those of skill in the art, each unit represented by subscript d is a methylene unit, such that linear hydrocarbon moiety may be defined or otherwise referred to as an alkylene group. It will also be appreciated that each methylene group may independently be unsubstituted and unbranched, or substituted (e.g. with a hydrogen atom replaced with a non-hydrogen atom or group) and/or branched (e.g. with a hydrogen atom replaced with an alkyl group). In certain embodiments, divalent linking group D¹ comprises, alternatively is, an unsubstituted alkylene group.

In some embodiments, divalent linking group D¹ comprises, alternatively is, a substituted hydrocarbon moiety, such as a substituted alkylene group. In such embodiments, divalent linking group D¹ may comprise a carbon backbone having at least 2 carbon atoms and at least one heteroatom (e.g. O, N, S, etc.), such that the backbone comprises an ether moiety, an amine moiety, etc. For example, in particular embodiments, divalent linking group D¹ comprises, alternatively is, an amino substituted hydrocarbon group (i.e., a hydrocarbon comprising a nitrogen-substituted carbon chain/backbone). For example, in some such embodiments, the divalent linking group D¹ is an amino substituted hydrocarbon having formula -D³-N(R⁴)-D³-, where each D³ is an independently selected divalent hydrocarbon group, and R⁴ is as defined above (i.e., a hydrocarbyl group, such as an alkyl group (e.g. methyl, ethyl, etc.). In certain embodiments, R⁴ is as methyl in the amino substituted hydrocarbon of the preceding formula. Each D³ typically comprises an independently selected alkylene group, such as any of those described above with respect to divalent linking group D¹. For example, in some embodiments, each D³ is independently selected from alkylene groups having from 1 to 8 carbon atoms, such as from 2 to 8, alternatively from 2 to 6, alternatively from 2 to 4 carbon atoms. In certain embodiments, each D³ is propylene (i.e., —(CH₂)₃—). However, it is to be appreciated that one or both D³ may be, or comprise, another divalent linking group (i.e., aside from the alkylene groups described above). Moreover, each D³ may be substituted or unsubstituted, linear or branched, and various combinations thereof.

With continued regard to formula (I), as introduced above, X¹ represents an epoxide-functional moiety, i.e., a moiety comprising an epoxide group. The epoxide group is not particular limited, and may be any group comprising an epoxide (e.g. a two carbon three-atom cyclic ether). For example, X¹ may comprise, or be, a cyclic epoxide or a linear epoxide. As understood by those of skill in the art, epoxides (e.g. epoxide groups) are generally described in terms of the carbon skeleton the two epoxide carbons compose (e.g. the epoxyalkane derived from epoxidation of an alkene). For example, linear epoxides generally comprise a linear hydrocarbon comprising two adjacent carbon atoms bonded to the same oxygen atom. Similarly, cyclic epoxides generally comprise cyclic hydrocarbon comprising two adjacent carbon atoms bonded to the same oxygen atom, where at least one, but typically both, adjacent carbon atom is in the ring of the cyclic structure (i.e., is part of both the epoxide ring and the hydrocarbon ring). The epoxide may be a terminal epoxide or an internal epoxide. Specific examples of suitable epoxides for X¹ include epoxyalkyl groups (e.g. epoxyethyl groups, epoxypropyl groups (i.e., oxiranylmethyl groups), oxiranylbutyl groups, epoxyhexyl groups, oxiranyloctyl groups, etc.), epoxycycloalkyl groups (e.g. epoxycyclopentyl groups, epoxycyclohexyl groups, etc.), glycidyloxyalkyl groups (e.g. a 3-glycidyloxypropyl group, a 4-glycidyloxybutyl group, etc.), and the like. One of skill in the art will appreciate that such epoxide groups may be substituted or unsubstituted.

In certain embodiments, X¹ comprises, alternatively is, a hydrocarbyl group substituted with an epoxyethyl group of the formula

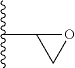 [SMILES: *C1CO1]

or an epoxycyclohexyl group of the formula

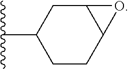 [SMILES: *C1CCC2OC2C1]

In particular embodiments, X¹ is an epoxypropyl group of formula

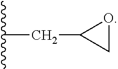 [SMILES: *CC1CO1]

With further regard to formula (I), as introduced above, each R¹ is independently selected from H and CH₃. Said differently, R¹ is independently H or CH₃ in each moiety indicated by subscript a, independently H or CH₃ in each moiety indicated by subscript b, and independently H or CH₃ in each moiety indicated by subscript c. In certain embodiments, R¹ is CH₃ in each moiety indicated by subscript a. In these or other embodiments, R¹ is CH₃ in each moiety indicated by subscript b. In these or other embodiments, R¹ is CH₃ in each moiety indicated by subscript c. In certain embodiments, R¹ is CH₃ in each moiety indicated by subscripts a and b, and R¹ is H in each moiety indicated by subscript c. It will be appreciated, however, that moieties indicated by subscripts a, b, and/or c may comprise a mixture of different R¹ groups. For example, in certain embodiments, R¹ is H in a predominant amount of moieties indicated by subscripts c, R¹ is CH₃ in the remaining moieties indicated by subscripts c.

With further regard to formula (I), as introduced above, R² represents H or a substituted or unsubstituted hydrocarbyl group. Typically, R² is a substituted or unsubstituted hydrocarbyl group. Examples of such hydrocarbyl groups include those described above with respect to R.

In some embodiments, R² is a hydrocarbyl group having from 1 to 20 carbon atoms. In certain such embodiments, R² comprises, alternatively is, an alkyl group. Suitable alkyl groups include saturated alkyl groups, which may be linear, branched, cyclic (e.g. monocyclic or polycyclic), or combinations thereof. Examples of such alkyl groups include those having the general formula CⱼH₂ⱼ₋₂ₖ₊₁, where subscript j is from 1 to 20 (i.e., the number of carbon atoms present in the alkyl group), subscript k is the number of independent rings/cyclic loops, and at least one carbon atom designated by subscript j is bonded to the carboxylic oxygen shown bonded to R² in formula (I) above. Examples of linear and branched isomers of such alkyl groups (i.e., where the alkyl group is free from cyclic groups such that subscript k=0), include those having the general formula CⱼH₂ⱼ₊₁, where subscript j is as defined above and at least one carbon atom designated by subscript j is bonded to the carboxylic oxygen shown bonded to R² in formula (I) above. Examples of monocyclic alkyl groups include those having the general formula CⱼH₂ⱼ₋₁, where subscript j is as defined above and at least one carbon atom designated by subscript j is bonded to the carboxylic oxygen shown bonded to R² in formula (I) above. Specific examples of such alkyl groups include methyl groups, ethyl groups, propyl groups, butyl groups, pentyl groups, hexyl groups, heptyl groups, octyl groups, nonyl groups, decyl groups, undecyl groups dodecyl groups, tridecyl groups, tetradecyl groups, pentadecyl groups, hexadecyl groups, heptadecyl groups, octadecyl groups, nonadecyl groups, and eicosyl groups, including linear, branched, and/or cyclic isomers thereof. For example, pentyl groups encompass n-pentyl (i.e., a linear isomer) and cyclopentyl (i.e., a cyclic isomer), as well as branched isomers such as isopentyl (i.e., 3-methylbutyl), neopentyl (i.e., 2,2-dimethylpropy), tert-pentyl (i.e., 2-methylbutan-2-yl), sec-pentyl (i.e., pentan-2-yl), sec-isopentyl (i.e., 3-methylbutan-2-yl) etc.), 3-pentyl (i.e., pentan-3-yl), and active pentyl (i.e., 2-methylbutyl).

In certain embodiments, each R² is independently selected from alkyl groups having from 1 to 12 carbon atoms, such as from 1 to 8, alternatively from 2 to 8, alternatively from 2 to 6 carbon atom(s). In such embodiments, each R² is typically selected from methyl groups, ethyl groups, propyl groups (e.g. n-propyl and iso-propyl groups), butyl groups (e.g. n-butyl, sec-butyl, iso-butyl, and tert-butyl groups), pentyl groups (e.g. those described above), hexyl groups, heptyl groups, etc., and the like, as well as derivatives and/or modifications thereof. Examples of derivatives and/or modifications of such alkyl groups include substituted versions thereof. For example, R² may comprise, alternatively may be, a hydroxyl ethyl group, which will be understood to be a derivative and/or a modification of the ethyl groups described above. Likewise, R² may comprise, alternatively may be, an acetoacetoxyethyl group, which will also be understood to be a derivative and/or a modification of the ethyl groups described above (e.g. as an acetoacetoxy-substituted ethyl group), as well as a derivative and/or a modification of other hydrocarbyl groups described above (e.g. a hexyl group substituted with an ester and a ketone, etc.).

In certain embodiments, each R² is independently selected from ethyl, n-butyl, isobutyl, isobornyl, cyclohexyl, neopentyl, 2-ethylhexyl, hydroxyethyl, and acetoacetoxyethyl groups. In particular embodiments, at least one R² is a butyl group (e.g. n-butyl).

Subscripts a, b, and c represent the number of monomeric units shown in formula (I) above, where the silicone-acrylate polymer comprises at least 1 of the moieties indicated by subscript a (i.e., subscript a 1), optionally, one or more of the moieties indicated by subscript b (i.e., subscript b 0), and, optionally, one or more of the moieties indicated by subscript c (i.e., subscript c≥0). The silicone-acrylate polymer contains at least two monomeric units such that a+b+c≥2. Said differently, in general, subscript a is at least 1, alternatively is greater than 1, subscript b is 0, 1, or greater than 1, and subscript c is 0, 1, or greater than 1. In certain embodiments, subscript a is a value of from 1 to 100, such as from 1 to 80, alternatively from 1 to 70, alternatively from 1 to 60, alternatively from 1 to 50, alternatively from 1 to 40, alternatively from 1 to 30, alternatively from 1 to 25, alternatively from 5 to 25. In these or other embodiments, subscript b is a value of from 1 to 100, such as from 1 to 80, alternatively from 1 to 70, alternatively from 1 to 60, alternatively from 1 to 50, alternatively from 1 to 40, alternatively from 1 to 30, alternatively from 1 to 20, alternatively from 1 to 10. In other embodiments, subscript b is 0. In particular embodiments, subscript c is 0. In other embodiments, subscript c≥1. For example, in some such embodiments, subscript c is a value of from 1 to 100, such as from 1 to 80, alternatively from 1 to 70, alternatively from 1 to 60, alternatively from 1 to 50, alternatively from 1 to 40, alternatively from 1 to 30, alternatively from 1 to 20, alternatively from 1 to 15.

In some embodiments, the silicone-acrylate polymer has a degree of polymerization (DP) or number-average degree of polymerization (Xn) of from 2 to 100, such as from 2 to 50, alternatively from 5 to 50, alternatively from 10 to 50, alternatively from 1 to 40, alternatively from 2 to 35, alternatively from 5 to 30, alternatively from 5 to 25. Alternatively from 5 to 20, alternatively from 5 to 15. In a specific embodiment, subscripts b and c are both 0 such that the silicone-acrylate polymer is a homopolymer. In other embodiments, subscript b is 0 and subscript c is 1 such that the silicone-acrylate polymer is a copolymer. Each unit indicated by c may be independently selected based on R², and the copolymer may be a terpolymer in view different moieties indicated by subscript c. Alternatively still, subscripts a, b, and c may all be 1. As understood in the art, DP is based on the number of monomeric units in the silicone-acrylate polymer, and Xn is a weighted mean of the degrees of polymerization of species of the silicone-acrylate polymer, weighted by the mole fractions (or the number of molecules) of the species. Methods of measuring DP and Xn are known in the art.

It will be appreciated that the moieties indicated by subscripts a, b, and c are independently selected. As such, for example, when subscript a is at least 2, the silicone-acrylate polymer may comprise more than one moiety indicated by subscript a (i.e., different from one another by different selections of R¹, D¹, and/or Y¹). Likewise, when subscript b is at least 2, the silicone-acrylate polymer may comprise more than one moiety indicated by subscript b (i.e., different from one another by different selections of R¹ and/or X¹). Similarly, when subscript c is at least 2, the silicone-acrylate polymer may comprise more than one moiety indicated by subscript c (i.e., different from one another by different selections of R¹ and/or R²). For example, in certain embodiments, subscript c is 0 and the silicone-acrylate polymer comprises more than one moiety indicated subscript a different from one another by different selections of Y¹, such that formula (I) above can be rewritten into the following general unit formula:

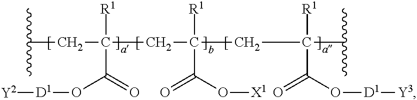

where Y² and Y³ are different selections of the siloxane moiety Y¹ described above, subscript a′ is ≥1, subscript a″ is ≥1, a′+a″=a (i.e., the sum of subscripts a′ and a″ equal subscript a of formula (I) described above), and each R¹, D¹, X¹, and subscript b is as defined and described above. In some such embodiments, for example, each Y² is independently a branched siloxane moiety having the general formula —Si(R³)₃ and each Y³ is independently a linear siloxane moiety having the following general formula:

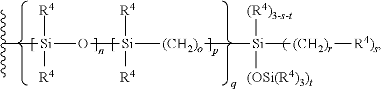

where each variable is as described above with respect to same particularly moieties of the siloxane moiety Y¹. One of skill in the art will appreciate that other combinations and variations within the silicone-acrylate polymer, i.e., with respect to the moieties indicated by subscripts a, b, and c, are equally possible within the bounds of the description and examples herein.

In certain embodiments, the silicone-acrylate polymer comprises a weight-average molecular weight (Mw) of from greater than 0 to 50,000 Da. For example, the silicone-acrylate polymer may comprise a Mw of from 100 to 40,000, alternatively from 100 to 30,000, alternatively from 100 to 20,000, alternatively from 100 to 10,000, alternatively from 500 to 5,000 Da. In specific embodiments, the silicon-acrylate polymer has a number average molecular weight (Mn) of from 500 to 5,000, alternatively from 1,000 to 3,000, alternatively from 1,500 to 2,500. In these or other embodiments, the silicone-acrylate polymer has a mass dispersity of from 1.1 to 10, alternatively from 1.5 to 5, alternatively from 1.5 to 4, alternatively from 1.5 to 3, alternatively from 1.5 to 2, alternatively from 1.5 to 1.65. In these or other embodiments, the silicone-acrylate polymer has a glass transition temperature (Tg) of from −20 to −70, alternatively from −20 to −60, alternatively from −30 to −70, alternatively from −30 to −60, ° C. The molecular weight(s) and mass dispersities of the silicone-acrylate polymer may be readily determined by techniques known in the art, such as via gel permeation chromatography (GPC) against polystyrene standards (e.g. using size exclusion chromatography (GPC/SEC)). Glass transition temperature (Tg) can be measured via Differential Scanning Calorimetry (DSC).

In certain embodiments, the liquid composition further comprises a carrier vehicle. When utilized, the carrier vehicle is non-aqueous. The carrier vehicle typically solubilizes the silicone-acrylate copolymer, and in such embodiments, is a solvent. In some embodiments, the carrier vehicle comprises, alternatively is, an organic solvent. Examples of organic solvents include: aromatic hydrocarbons, such as benzene, toluene, xylene, mesitylene, etc.; aliphatic hydrocarbons, such as heptane, hexane, octane, etc.; glycol ethers, such as propylene glycol methyl ether, dipropylene glycol methyl ether, propylene glycol n-butyl ether, propylene glycol n-propyl ether, ethylene glycol n-butyl ether, etc.; halogenated hydrocarbons, such as dichloromethane, 1,1,1-trichloroethane, and chloroform; ketones, such as acetone, methylethyl ketone, or methyl isobutyl ketone; acetates, such as ethyl acetate, butyl acetate, ethylene glycol monoethyl ether acetate, and propylene glycol methyl ether acetate; alcohols, such as methanol, ethanol, isopropanol, butanol, or n-propanol; and others organic compounds that present as liquid/fluid at typical reaction temperatures, such as dimethyl sulfoxide, dimethyl formamide, acetonitrile, tetrahydrofuran, white spirits, mineral spirits, naphtha, n-methylpyrrolidone; and the like, as well as derivatives, modifications, and combination thereof.

The liquid composition is a liquid regardless of the presence of absence of the carrier vehicle. For example, viscosity of the silicone-acrylate polymer can be controlled such that the silicone-acrylate polymer is a liquid in the absence of any carrier vehicle. In certain embodiments, the liquid silicone composition consists essentially of, alternatively consists of, the silicone-acrylate polymer and optionally the carrier vehicle.

The liquid composition has a volatile organic compound (VOC) content of from 0 to 25 wt. % based on the total weight of the liquid composition. VOCs are known in the art and are typically attributable to the presence of organic solvents. For purposes of this disclosure, VOCs are not based on any regulatory definition of VOCs, e.g. as defined by any governmental body, but instead are based on VOCs regardless of environmental impact. In various embodiments, VOCs are organic solvents. In these or other embodiments, VOCs are organic compounds that have a vapor pressure such that the VOCs can volatilize (i.e., evaporate or sublimate) at room (25° C.) or elevated (e.g. from greater than 25 to 200° C.) temperature.

In certain embodiments, the liquid composition is free from VOCs. In other embodiments, the liquid composition has a VOC content of from greater than 0 to 25, alternatively from greater than 0 to 20, alternatively from greater than 0 to 15, alternatively from greater than 0 to 10, alternatively from greater than 0 to 5, weight percent based on the total weight of the liquid composition. In contrast, conventional silicone-acrylate polymers or copolymers have significant VOC content, as a high weight percent of organic solvent is required to solubilize high molecular weight and often solid silicone-acrylate polymers. In contrast, the inventive liquid composition is a liquid having low VOC content, alternatively no VOC content.

A method of preparing the liquid composition is also disclosed. The method comprising combining the silicone-acrylate polymer and optionally the carrier vehicle. In certain embodiments, the method further comprises preparing the silicone-acrylate polymer. The method of preparing the silicone-acrylate polymer comprises reacting (A) an acryloxy-functional organosilicon component, optionally (B) an epoxy-functional acrylate component, and optionally (C) an acrylate component, to give the silicone-acrylate polymer.

As will be appreciated by those of skill in the art in view of the description herein, each of components (A), (B), and (C) comprises a monomer that forms a unit represented in formula (I) of the silicone-acrylate polymer described above (e.g. via polymerization/reaction). Accordingly, the description above with regard to particular functional groups and variables of the silicone-acrylate polymer (e.g. R¹, D¹, and Y¹, X¹, R²) applies equally to the particular monomers utilized in the preparation method, which are described in turn below.

The acryloxy-functional organosilicon component (A) comprises an acryloxy-functional organosilicon monomer having the general formula:

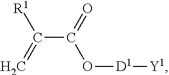

where R¹, D¹, and Y¹ are as defined and described above. More specifically, as will be appreciated by those of skill in the art in view of the description herein, the acryloxy-functional organosilicon monomer of component (A) forms moieties indicated by subscript a in formula (I) of the silicone-acrylate polymer described above. As such, the description above with regard to R¹, D¹, and Y¹ of the silicone-acrylate polymer applies equally to the acryloxy-functional organosilicon monomer.

For example, in certain embodiments, D¹ comprises a linear alkylene group, optionally substituted with an alkyl amino group, and Y¹ comprises a branched siloxane moiety. In such embodiments, the acryloxy-functional organosilicon monomer may have the following general formula:

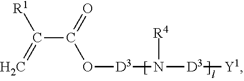

where each D³ is an independently selected linear alkylene group having from 2 to 6 carbon atoms, R⁴ is an alkyl group (e.g. methyl, ethyl, etc.), subscript I is 0 or 1, and R¹ and Y¹ are as defined and described above. In some such embodiments, subscript I is 1, each D³ is a propylene group, and R⁴ is methyl, such that the acryloxy-functional organosilicon monomer has the following general formula:

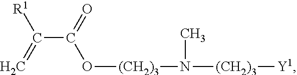

where R¹ and Y¹ are as defined and described above. In other such embodiments, subscript I is 0 and D³ is a propylene group, such that the acryloxy-functional organosilicon monomer has the following general formula:

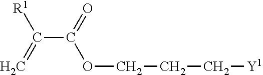

where R and Y are as defined and described above.

With regard to the preceding formulae of the acryloxy-functional organosilicon monomer, the siloxane monomer may be linear or branched. For example, in some embodiments, Y¹ is a branched siloxane of formula —Si(R³)₃ as defined and described above. In some such embodiments, Y¹ is selected from the following branched siloxane moieties (i)-(iv):

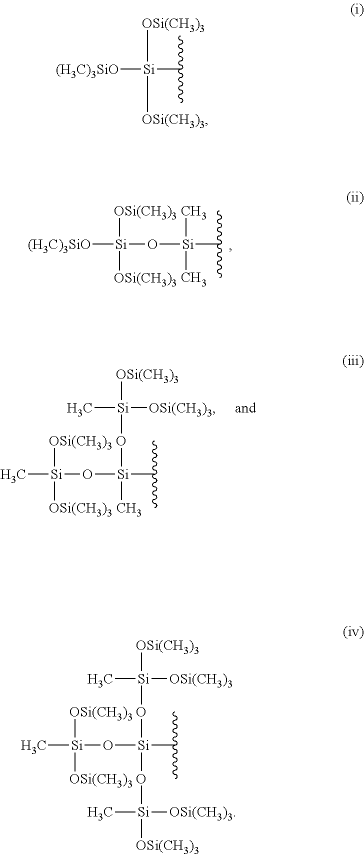

In some embodiments, Y¹ is a linear siloxane moiety having the following general formula:

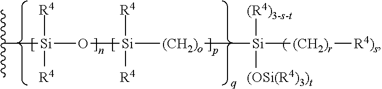

where each of subscripts n, o, p, q, r, s, and t and each R⁴ is as defined and described above. For example, in some such embodiments, each R⁴ is methyl, such that Y¹ is a linear siloxane moiety having the following general formula:

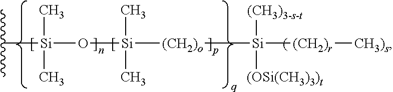

where subscripts n, o, p, q, r, s, and t are as defined and described above. However, it is to be appreciated that any R⁴ may be selected from other hydrocarbyl groups, such as those described above. In some such embodiments, Y¹ is selected from the following siloxane moieties (i)-(iii):

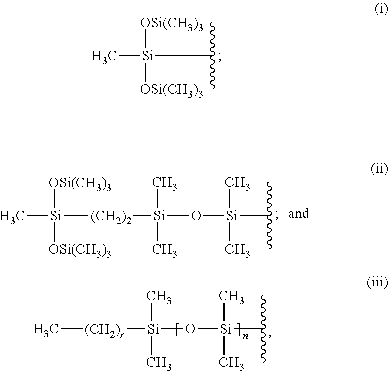

where 1≤n≤100 and subscript r is from 3 to 9.

With regard to the preceding formulae of the acryloxy-functional organosilicon monomer, R¹ is H or CH₃. In certain embodiments, R¹ is H (i.e., the acryloxy-functional organosilicon monomer comprises an acryloxy group). In other embodiments, R¹ is CH₃ such that the acryloxy-functional organosilicon component (A) comprises a (meth)acryloxy-functional organosilicon monomer (i.e., the acryloxy-functional organosilicon monomer is further defined as (meth)acryloxy-functional). In both instances, as will be understood by those of skill in the art, the term acryloxy-functional may be used to denote a genus encompassing both unsubstituted acryloxy functionality (e.g., where R¹ is H) as well as methyl-substituted acryloxy functionality (e.g., where R¹ is CH₃), just as the term “acrylate” is conventionally understood to encompass acrylic esters, (meth)acrylic esters, etc.

The acryloxy-functional organosilicon monomer may be utilized in any amount in component (A), which will be selected by one of skill in the art, e.g. dependent upon the particular components selected for reacting, the reaction parameters employed, the scale of the reaction (e.g. total amounts of the acryloxy-functional organosilicon monomer to be reacted and/or silicone-acrylate polymer to be prepared), etc.

The acryloxy-functional organosilicon monomer may be prepared or otherwise obtained, i.e., as a prepared compound. Methods of preparing the acryloxy-functional organosilicon monomer are known in the art, with such compounds and suitable starting materials commercially available from various suppliers. Preparing the acryloxy-functional organosilicon monomer, when part of the method, may be performed prior to combining the same with, or in the presence of, any other component of the acryloxy-functional organosilicon component (A).

Likewise, the acryloxy-functional organosilicon monomer may be utilized in any form in component (A), such as neat (i.e., absent solvents, carrier vehicles, diluents, etc.), or disposed in a carrier vehicle, such as a solvent or dispersant. For example, the acryloxy-functional organosilicon component (A) may comprise a carrier vehicle, such as one of those described herein. It will be appreciated that the acryloxy-functional organosilicon monomer may be combined with the carrier vehicle, if utilized, prior to, during, or after being combined with any one or more other components of the acryloxy-functional organosilicon component (A). In some embodiments, the acryloxy-functional organosilicon component (A) is free from, alternatively substantially free from carrier vehicles. For example, in certain embodiments, the method may comprise stripping the acryloxy-functional organosilicon monomer of volatiles and/or solvents, or distilling the acryloxy-functional organosilicon monomer from solvents, volatiles, etc., to prepare the acryloxy-functional organosilicon component (A).

The acryloxy-functional organosilicon component (A) may comprise but one type of acryloxy-functional organosilicon monomer or, alternatively, may comprise more than one type of acryloxy-functional organosilicon monomer, such as two, three, or more acryloxy-functional organosilicon monomers that differ from one another with regard to at least one of variables R¹, D¹, and Y¹ as defined and described above.

The epoxy-functional acrylate component (B), which is optional, comprises an oxiranyl-functional acryloxy monomer (i.e., an oxiranyl acrylate ester monomer) having the general formula:

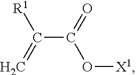

where R¹ and X¹ are as defined and described above. More specifically, as will be appreciated by those of skill in the art in view of the description herein, the oxiranyl-functional acryloxy monomer of component (B) forms moieties indicated by subscript b in formula (I) of the silicone-acrylate polymer described above. As such, the description above with regard to R¹ and X¹ of the silicone-acrylate polymer applies equally to the oxiranyl-functional acryloxy monomer of component (B).

For example, in certain embodiments, X¹ comprises an epoxyalkyl group (e.g. an epoxyethyl group, epoxypropyl group (i.e., oxiranylmethyl group), oxiranylbutyl group, epoxyhexyl group, oxiranyloctyl group, etc.) or an epoxycycloalkyl group (e.g. an epoxycyclopentyl group, epoxycyclohexyl groups, etc.). For example, in some embodiments, X¹ comprises, alternatively is, a hydrocarbyl group substituted with an epoxyethyl group of the formula

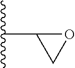 [SMILES: *C1CO1]

or an epoxycyclohexyl group of the formula.

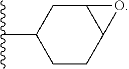 [SMILES: *C1CCC2OC2C1]

In particular embodiments, X¹ is an epoxypropyl group of formula

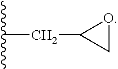 [SMILES: *CC1CO1]

With regard to the preceding formulae of the oxiranyl-functional acryloxy monomer, R¹ is H or CH₃. In certain embodiments, R¹ is H (i.e., the oxiranyl-functional acryloxy monomer comprises an acryloxy group). In other embodiments, R¹ is CH₃ such that the epoxy-functional acrylate component (B) comprises an oxiranyl-functional (meth)acryloxy monomer.

In view of the description herein, one of skill in the art will appreciate that examples of suitable oxiranyl-functional acryloxy monomers for use in or as component (B) include glycidyl acrylates, epoxycyclohexyl acrylates, and the like. For example, in certain embodiments, epoxy-functional acrylate component (B) comprises glycidyl acrylate, glycidyl (meth)acrylate, glycidyloxybutyl acrylate, (3,4-epoxycyclohexyl)methyl acrylate, (3,4-epoxycyclohexyl)methyl (meth)acrylate, (3,4-epoxycyclohexyl)ethyl acrylate, (3,4-epoxycyclohexyl)ethyl (meth)acrylate, or a combination thereof.

The oxiranyl-functional acryloxy monomer may be utilized in any amount in component (B), when component (B) is utilized, which will be selected by one of skill in the art, e.g. dependent upon the particular components selected for reacting, the reaction parameters employed, the scale of the reaction (e.g. total amounts of the oxiranyl-functional acryloxy monomer to be reacted and/or silicone-acrylate polymer to be prepared), etc.

The oxiranyl-functional acryloxy monomer may be prepared or otherwise obtained, i.e., as a prepared compound. Methods of preparing the oxiranyl-functional acryloxy monomer are known in the art, with such compounds and suitable starting materials commercially available from various suppliers. Preparing the oxiranyl-functional acryloxy monomer, when part of the method, may be performed prior to combining the same with, or in the presence of, any other component of the epoxy-functional acrylate component (B).

Likewise, the oxiranyl-functional acryloxy monomer may be utilized, if at all, in any form in component (B), such as neat (i.e., absent solvents, carrier vehicles, diluents, etc.), or disposed in a carrier vehicle, such as a solvent or dispersant. For example, the epoxy-functional acrylate component (B) may comprise a carrier vehicle, such as one of those described herein. It will be appreciated that the oxiranyl-functional acryloxy monomer may be combined with the carrier vehicle, if utilized, prior to, during, or after being combined with any one or more other components of the epoxy-functional acrylate component (B). In some embodiments, the epoxy-functional acrylate component (B) is free from, alternatively substantially free from carrier vehicles. For example, in certain embodiments, the method may comprise stripping the oxiranyl-functional acryloxy monomer of volatiles and/or solvents, or distilling the oxiranyl-functional acryloxy monomer from solvents, volatiles, etc., to prepare the epoxy-functional acrylate component (B) (e.g. when the method includes preparing the oxiranyl-functional acryloxy monomer).

The epoxy-functional acrylate component (B), if utilized, may comprise but one type of oxiranyl-functional acryloxy monomer or, alternatively, may comprise more than one type of oxiranyl-functional acryloxy monomer, such as two, three, or more oxiranyl-functional acryloxy monomers that differ from one another with regard to at least one of variables R¹ and X¹ as defined and described above.

The acrylate component (C) is optional and comprises an acrylate monomer having the general formula:

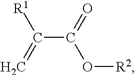

where R¹ and R² are as defined and described above. More specifically, as will be appreciated by those of skill in the art in view of the description herein, the acrylate monomer of component (C) forms moieties indicated by subscript c in formula (I) of the silicone-acrylate polymer described above. As such, the description above with regard to R¹ and R² of the silicone-acrylate polymer applies equally to the acrylate monomer of component (C).

As introduced above, R¹ is H or CH₃ and R² is H or a hydrocarbyl group, and is typically a hydrocarbyl group. Accordingly, the acrylate monomer is generally selected from substituted and unsubstituted acrylic acids, substituted and unsubstituted acrylic esters, such as acrylate esters (i.e., “acrylates”) and (meth)acrylate esters (i.e., “(meth)acrylates,” or “methacrylates”)acrylic esters, which may also be referred to as acryloxy or (meth)acryloxy-functional hydrocarbon compounds, respectively, and may be monofunctional or polyfunctional (e.g. with respect to the number of acryloxy groups thereon).

Examples of specific monofunctional acrylic esters suitable for use as the acrylate monomer of component (C) include (alkyl)acrylic compounds, such as methyl acrylate, phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2-phenylphenoxyethyl (meth)acrylate, 4-phenylphenoxyethyl (meth)acrylate, 3-(2-phenylphenyl)-2-hydroxypropyl (meth)acrylate, polyoxyethylene-modified p-cumylphenol(meth)acrylate, 2-bromophenoxyethyl (meth)acrylate, 2,4-dibromophenoxyethyl (meth)acrylate, 2,4,6-tribromophenoxyethyl (meth)acrylate, polyoxyethylene-modified phenoxy(meth)acrylate, polyoxypropylene-modified phenoxy(meth)acrylate, polyoxyethylene nonylphenyl ether(meth)acrylate, isobornyl (meth)acrylate, 1-adamantyl (meth)acrylate, 2-methyl-2-adamantyl (meth)acrylate, 2-ethyl-2-adamantyl (meth)acrylate, bornyl(meth)acrylate, tricyclodecanyl(meth)acrylate, dicyclopentanyl (meth)acrylate, dicyclopentenyl(meth)acrylate, cyclohexyl (meth)acrylate, 4-butylcyclohexyl (meth)acrylate, acryloylmorpholine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl(meth)acrylate, isobutyl (meth)acrylate, t-butyl (meth)acrylate, pentyl(meth)acrylate, isoamyl(meth)acrylate, hexyl(meth)acrylate, heptyl(meth)acrylate, octyl (meth)acrylate, isooctyl (meth)acrylate, 2-ethylhexyl (meth)acrylate, nonyl(meth)acrylate, decyl(meth)acrylate, isodecyl(meth)acrylate, undecyl(meth)acrylate, dodecyl (meth)acrylate, lauryl (meth)acrylate, stearyl (meth)acrylate, isostearyl (meth)acrylate, benzyl (meth)acrylate, 1-naphthylmethyl (meth)acrylate, 2-naphthylmethyl (meth)acrylate, tetrahydrofurfuryl (meth)acrylate, butoxyethyl (meth)acrylate, ethoxydiethylene glycol (meth)acrylate, poly(ethylene glycol) mono(meth)acrylate, poly(propylene glycol) mono(meth)acrylate, methoxyethylene glycol (meth)acrylate, ethoxyethyl (meth)acrylate, methoxypoly(ethylene glycol)(meth)acrylate, methoxypoly(propylene glycol) (meth)acrylate, and the like, as well as derivatives thereof.

Examples of specific polyfunctional acrylic monomers include (alkyl)acrylic compounds having two or more acryloyl or methacryloyl groups, such as trimethylolpropane di(meth)acrylate, trimethylolpropane tri(meth)acrylate, polyoxyethylene-modified trimethylolpropane tri(meth)acrylate, polyoxypropylene-modified trimethylolpropane tri(meth)acrylate, polyoxyethylene/polyoxypropylene-modified trimethylolpropane tri(meth)acrylate, dimethyloltricyclodecane di(meth)acrylate, pentaerythritol tri(meth)acrylate, pentaerythritol tetra(meth)acrylate, ethylene glycol di(meth)acrylate, tetraethylene glycol di(meth)acrylate, phenylethylene glycol di(meth)acrylate, poly(ethylene glycol)di(meth)acrylate, poly(propylene glycol)di(meth)acrylate, 1,4-butanediol di(meth)acrylate, 1,6-hexanediol di(meth)acrylate, neopentyl glycol di(meth)acrylate, 1,9-nonanediol di(meth)acrylate, 1,10-decanediol di(meth)acrylate, 1,3-adamantanedimethanol di(meth)acrylate, o-xylylene di(meth)acrylate, m-xylylene di(meth)acrylate, p-xylylene di(meth)acrylate, tris(2-hydroxyethyl)isocyanurate tri(meth)acrylate, tris(acryloyloxy) isocyanurate, bis(hydroxymethyl)tricyclodecane di(meth)acrylate, dipentaerythritol penta(meth)acrylate, dipentaerythritol hexa(meth)acrylate, polyoxyethylene-modified 2,2-bis(4-((meth)acryloxy)phenyl)propane, polyoxypropylene-modified 2,2-bis(4-((meth)acryloxy)phenyl)propane, polyoxyethylene/polyoxypropylene-modified 2,2-bis(4-((meth)acryloxy)phenyl)propane, and the like, as well as derivatives thereof.

It is to be appreciated that the exemplary acrylic monomers above are described in terms of (meth)acrylate species only for brevity, and that one of skill in the art will readily understand that other alkyl and/or hydrido versions of such compounds may equally be utilized. For example, one of skill in the art will understand that the monomer “2-ethylhexyl (meth)acrylate” listed above exemplifies both 2-ethylhexyl (meth)acrylate as well as 2-ethylhexyl acrylate. Likewise, while the acrylic monomers are described generally as propenoates (i.e., α,β-unsaturated esters) in the examples above, it is to be appreciated that the that the term “acrylate” used in these descriptions may equally refer to an acid, salt, and/or conjugate base of the esters exemplified. For example, one of skill in the art will understand that the monomer “methyl acrylate” listed above exemplifies the methyl ester of acrylic acid, as well as acrylic acid, acrylate salts (e.g. sodium acrylate), etc. Furthermore, multifunctional derivatives/variations of the acrylic monomers described above may also be utilized. For example, the monomers “ethyl (meth)acrylate” listed above exemplifies functionalized-derivatives, such as substituted ethyl (meth)acrylates and ethyl acrylates (e.g. hydroxyethyl(meth)acrylate and hydroxyethyl acrylate, respectively).

In certain embodiments, the acrylic ester monomer of component (C), if utilized, is selected from methyl acrylate (MA), ethyl acrylate (EA), n-butyl acrylate (BA), isobutyl acrylate, isobornyl acrylate, cyclohexyl acrylate, neopentyl acrylate, 2-ethylhexyl acrylate (2-EHA), hydroxyethyl acrylate (HEA), methyl (meth)acrylate (MMA), ethyl (meth)acrylate (EMA), n-butyl (meth)acrylate (BMA), isobutyl (meth)acrylate, isobornyl (meth)acrylate, cyclohexyl (meth)acrylate, neopentyl (meth)acrylate, 2-ethylhexyl (meth)acrylate (2-EHMA), hydroxyethyl (meth)acrylate (HEMA), and acetoacetoxyethyl (meth)acrylate (AAEM).

The acrylic ester monomer may be utilized in any amount in component (C), if utilized at all, which will be selected by one of skill in the art, e.g. dependent upon the particular components selected for reacting, the reaction parameters employed, the scale of the reaction (e.g. total amounts of the acrylic ester monomer to be reacted and/or silicone-acrylate polymer to be prepared), etc.

The acrylic ester monomer may be prepared or otherwise obtained, i.e., as a prepared compound. Methods of preparing the acrylic ester monomer are known in the art, with such compounds and suitable starting materials commercially available from various suppliers. Preparing the acrylic ester monomer, when part of the method, may be performed prior to combining the same with, or in the presence of, any other component of the acrylate component (C). In general, methods of preparing acrylate-functional compounds utilize at least one acrylic monomer having an acryloyloxy or alkylacryloyloxy group (i.e., acrylates, alkylacrylates, acrylic acids, alkylacrylic acids, and the like, as well as derivatives and/or combinations thereof). Such acrylic monomers may be monofunctional or polyfunctional acrylic monomers.

Likewise, the acrylic ester monomer may be utilized in any form in component (C), when utilized, such as neat (i.e., absent solvents, carrier vehicles, diluents, etc.), or disposed in a carrier vehicle, such as a solvent or dispersant. For example, the acrylate component (C) may comprise a carrier vehicle, such as one of those described herein. It will be appreciated that the acrylic ester monomer may be combined with the carrier vehicle, if utilized, prior to, during, or after being combined with any one or more other components of the acrylate component (C). In some embodiments, the acrylate component (C) is free from, alternatively substantially free from carrier vehicles. For example, in certain embodiments, the method may comprise stripping the acrylic ester monomer of volatiles and/or solvents, or distilling the acrylic ester monomer from solvents, volatiles, etc., to prepare the acrylate component (C) (e.g. when the method includes preparing the acrylic ester monomer).

The acrylate component (C), if utilized, may comprise but one type of acrylic ester monomer or, alternatively, may comprise more than one type of acrylic ester monomer, such as two, three, or more acryloxy-functional organosilicon monomers that differ from one another with regard to at least one of variables R¹ and R² as defined and described above.

Moreover, the acrylate component (C), if utilized, may comprise additional monomers or coreactants, i.e., other than the acrylic ester monomer(s) described above, The additional monomer(s)/coreactants are not particularly limited, and may be selected from carboxylic acid monomers, such as acrylic acid (AA), (meth)acrylic acid (MAA), and derivatives thereof (e.g. acids of any of the acrylate esters described above), itaconic acid, and salts thereof; acrylamide monomers, such as amide derivatives/forms of any of the acrylate esters described above (e.g. isodecylacrylamide, diacetone(meth)acrylamide, isobutoxymethyl (meth)acrylamide, N,N-dimethyl (meth)acrylamide, t-octyl(meth)acrylamide, dimethylaminoethyl (meth)acrylate, diethylaminoethyl (meth)acrylate, 7-amino-3,7-dimethyloctyl(meth)acrylate, N,N-diethyl (meth)acrylamide, N,N-dimethylaminopropyl (meth)acrylamide, etc.); sulfonic acid monomers, such as sodium styrene sulfonate, acrylamido-methyl-propane sulfonate, and salts thereof; phosphoric acid monomers, such as phosphoethylmethacrylate and salts thereof; other monomers such as styrene, acrylonitrile, and copolymerized multi-ethylenically unsaturated monomer groups (e.g. allyl(meth)acrylate, diallyl phthalate, 1,4-butylene glycol di(meth)acrylate, 1,2-ethylene glycol di(meth)acrylate, 1,6-hexanediol di(meth)acrylate, divinyl benzene, etc.); and the like, as well as derivatives, modifications, and combinations thereof. It may also be advantageous to incorporate such monomer groups non-uniformly into the silicone-acrylate polymer to form multiphase particles, e.g. having a core-shell, hemispherical, or occluded morphology.

It is to be appreciated that the description of optional components below in regards to preparing the silicone-acrylate polymer are based on components (B) and (C) being optional, and thus any reference to components (A), (B), and (C) is not to be construed as requiring components (B) and (C), but instead the collective components utilized to prepare the silicone-acrylate copolymer, including optional components.

In certain embodiments, the acryloxy-functional organosilicon component (A), optionally the epoxy-functional acrylate component (B), and optionally the acrylate component (C), are reacted in the presence of (D) a free radical initiator (i.e., the “initiator (D)”) to prepare the silicone-acrylate polymer.

The particular type or specific compound(s) selected for use in or as the initiator (D) will be readily selected by those of skill in the art based on the particular components (A) and optionally (B) and optionally (C) selected, any carrier vehicle present in the reaction, if any, etc. In general, the initiator (D) is not particularly limited, and may comprise or be any compound suitable for facilitating the polymerization of the alkenyl functionality of the various monomer(s) of components (A), (B), and (C) (e.g. via radical polymerization, radical coupling, etc.), as will be understood by one of skill in the art in view of the description herein. As such, the initiator (D) is typically a radical polymerization initiator, such as any of those conventionally used in polymerization of vinyl-functional compounds.

Examples of initiators include various peroxides, such as inorganic peroxides (e.g. hydrogen peroxide derivatives of potassium persulfate, sodium persulfate, ammonium persulfate, etc.) and various organic peroxides including benzoyl peroxide, t-butylperoxy maleic acid, succinic acid peroxides, t-butyl hydroperoxide, tert-butyl peroxypivalate (tBPPiv), etc. Additional examples of initiators include compounds that generates a free radical upon exposure to a reaction condition, e.g. when exited by a certain type of energy source (e.g. heat, UV light, etc.) etc. Examples of such compounds include (2,2,6,6-Tetramethylpiperidin-1-yl)oxyl (TEMPO), triazines, thiazines such as 10-phenylphenothiazine, 9,9′-bixanthene-9,9′-diol, 2,2-dimethoxy-2-phenylacetophenone, peroxides such as 2,5-dimethyl-2,5-di-(tert-butylperoxy)hexane (DBPH), and the like, as well as derivatives, modifications, and combinations thereof. In some embodiments, the initiator (D) may comprise or be a photoactivatable catalyst, which may initiate polymerization via irradiation and/or heat (e.g. upon exposure to radiation having a wavelength of from 150 to 800 nanometers (nm), etc.). For example, in certain embodiments, the initiator (D) may comprise a fac-tris(2-phenylpyridine)-based catalyst, which may be utilized to polymerize the monomers of components (A), (B), and (C) utilized via a reaction comprising light-mediated radical generation. Other examples of suitable initiators aside from those above (e.g. various peroxy and azo compounds), are known in the art.

The initiator (D) may be utilized in any amount, which will be selected by one of skill in the art, e.g. dependent upon the particular initiator (D) selected (e.g. the concentration/amount of active components thereof, the type of catalyst being utilized, etc.), the reaction parameters employed, the scale of the reaction (e.g. total amounts of components (A), (B), (C) utilized, etc. The molar ratio of the initiator (D) to components (A), (B), and (C) (i.e., the monomers thereof) utilized in the reaction may influence the rate and/or amount of polymerization to prepare the silicone-acrylate polymer. Thus, the amount of the initiator (D) as compared to the monomers of components (A), (B), and (C), as well as the molar ratios therebetween, may vary. Typically, these relative amounts and the molar ratio are selected to maximize the reaction of components (A), (B), and (C), while minimizing the loading of the initiator (D) (e.g. for increased economic efficiency of the reaction, increased ease of purification of the reaction product formed, etc.).

In certain embodiments, the initiator (D) is utilized in a range of from 0.01 to 20 parts by weight, alternatively from 0.1 to 10 parts by weight, based on 100 parts by weight total of component (A).

In certain embodiments, the initiator (D) is utilized in the reaction in an amount of from 0.01 to 20 wt. %, based on the total amount of component (A) utilized (i.e., wt./wt.). For example, the initiator (D) may be used in an amount of from 0.01 to 15 wt. %, such as from 0.1 to 15, alternatively of from 0.1 to 10 wt. %, based on the total amount of component (A) utilized. In other embodiments, the initiator (D) is utilized in the reaction in an amount of from 0.01 to 20 wt. %, based on the total amount of components (A), (B), and (C) utilized, such as in an amount of from 0.01 to 15 wt. %, alternatively of from 0.1 to 15, alternatively of from 1 to 10 wt. %, based on the total amount of components (A), (B), and (C). It will be appreciated that ratios outside of these ranges may be utilized as well, and the initiator (D) may be utilized in one or more portions, each within one of the ranges above (e.g. such as when additional initiator (D) may be utilized during the reaction of components (A), (B), and (C) to reach or otherwise move toward completion. It is also to be appreciated that the initiator (D) may itself comprise more than one type of initiator compound, such as two, three, or more different initiator compounds, which may be individually or collectively utilized in an amount within one of the ranges above.

In certain embodiments, the acryloxy-functional organosilicon component (A), optionally the epoxy-functional acrylate component (B), and optionally the acrylate component (C), are reacted in the presence of (E) a solvent to prepare the silicone-acrylate polymer. Solvents used herein are those that help fluidize the starting materials (i.e., components (A), (B), and (C)) but essentially do not react with any of these starting materials, and are otherwise not particularly limited. As such, the solvent will be selected based on solubility of the starting materials, the volatility (i.e., vapor pressure) of the solvent, the parameters of the preparation method employed, etc. The solubility refers to the solvent being sufficient to dissolve and/or disperse components (A), (B), and (C). Examples of particular solvents include any of the carrier vehicles, fluids, etc. suitable to sufficiently carry, dissolve, and/or disperse any component(s) of the reaction mixture during the preparation of the silicone-acrylate polymer.

In some embodiments, the solvent (E) comprises, alternatively is, an organic solvent. Examples of organic solvents include: aromatic hydrocarbons, such as benzene, toluene, xylene, mesitylene, etc.; aliphatic hydrocarbons, such as heptane, hexane, octane, etc.; glycol ethers, such as propylene glycol methyl ether, dipropylene glycol methyl ether, propylene glycol n-butyl ether, propylene glycol n-propyl ether, ethylene glycol n-butyl ether, etc.; halogenated hydrocarbons, such as dichloromethane, 1,1,1-trichloroethane, and chloroform; ketones, such as acetone, methylethyl ketone, or methyl isobutyl ketone; acetates, such as ethyl acetate, butyl acetate, ethylene glycol monoethyl ether acetate, and propylene glycol methyl ether acetate; alcohols, such as methanol, ethanol, isopropanol, butanol, or n-propanol; and others organic compounds that present as liquid/fluid at typical reaction temperatures, such as dimethyl sulfoxide, dimethyl formamide, acetonitrile, tetrahydrofuran, white spirits, mineral spirits, naphtha, n-methylpyrrolidone; and the like, as well as derivatives, modifications, and combination thereof.

In certain embodiments, the reaction of components (A), (B), and (C) is carried out in the absence of any carrier vehicle or solvent. For example, no carrier vehicle or solvent may be combined discretely with the acryloxy-functional organosilicon component (A), the epoxy-functional acrylate component (B), the acrylate component (C), and/or the initiator (D). In these or other embodiments, none of components (A), (B), (C), and (D) are disposed in any carrier vehicle or solvent, such that no carrier vehicle or solvent is present in the reaction mixture during the polymerization (i.e., the reaction mixture is free from, alternatively substantially free from, solvents). The above notwithstanding, in certain embodiments, one or more of components (A), (B), and (C) may be a carrier, e.g. when utilized as a fluid in an amount sufficient to carry, dissolve, or disperse any other component(s) of the reaction mixture.

The amount of solvent (E) utilized can depend on various factors, including the type of solvent selected, the amount and type of components (A), (B), (C), and (D) employed, etc. Typically, the amount of solvent (E) may range from 0.1 to 99 wt. %, based on combined weights of components (A), (B), and (C). In some embodiments, the solvent (E) is utilized in an amount of from 1 to 99 wt. %, such as from 2 to 99, alternatively of from 2 to 95, alternatively of from 2 to 90, alternatively of from 2 to 80, alternatively of from 2 to 70, alternatively of from 2 to 60, alternatively of from 2 to 50 wt. %, based on combined weights of components (A), (B), and (C). In other embodiments, the solvent (E) is utilized in an amount of from 50 to 99 wt. %, such as from 60 to 99, alternatively of from 70 to 99, alternatively of from 80 to 99, alternatively of from 90 to 99, alternatively of from 95 to 99 wt. %, based on combined weights of components (A), (B), and (C).

In certain embodiments, the acryloxy-functional organosilicon component (A), optionally the epoxy-functional acrylate component (B), and optionally the acrylate component (C), are reacted in the presence of (F) a chain-transfer agent to prepare the silicone-acrylate polymer. Compounds suitable for use in or as the chain-transfer agent (F) (i.e., in a radical polymerization of the acryloxy-functional monomers of components (A), (B), and (C)) are known in the art, and are exemplified by various thiol compounds.

For example, in some embodiments, the chain-transfer agent (F) comprises, alternatively is, a thiol compound having the general formula X—SH, where X is selected from substituted and unsubstituted hydrocarbon moieties, organosilicon moieties, and combinations thereof, such as any of those described above with respect to R. Examples of such thiol compounds include dodecylmercaptan (i.e., dodecanethiol), 2-mercaptoethanol, butylmercaptopropionate, methylmercaptopropionate, mercaptopropionic acid, and the like, as well as combinations thereof. Other examples of thiol compounds suitable for the chain-transfer agent (F) include mercaptotrialkoxy silanes, mercaptodialkoxy silanes, and mercaptomonoalkoxy silanes. For example, in some embodiments, the chain-transfer agent (F) comprises, alternatively is, (H₃CO)₂(H₃C)Si(CH₂)₃SH. In these or other embodiments, the chain-transfer agent (F) comprises, alternatively is, dodecanethiol.

The chain-transfer agent (F) is typically utilized to terminate growing polymer chains (e.g. formed via the polymerization of the monomers of components (A), (B), and (C)), and initiate formation of new polymer chains. In this fashion the chain-transfer agent (F) may be utilized to both control the molecular weight of the silicone-acrylate polymer being prepared, as well as to select the end-functionalization of the polymer chains. For example, when the chain-transfer agent (F) comprises dodecanethiol, the silicone-acrylate polymer being prepared may comprise the following general formula:

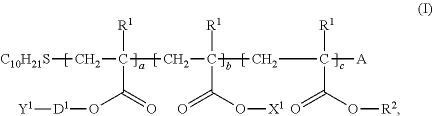

where A is a terminating group (e.g. H, or a moiety derived from a reactant or component of the reaction, such as one of the monomers of components (A), (B), or (C), the initiator (D), the chain-transfer agent (F), etc.), and each Y¹, D¹, X¹, R¹, R² subscript a, subscript b, and subscript c are independently selected and as defined above.

In certain embodiments, the chain-transfer agent (F) is utilized in the reaction in an amount of from 0.1 to 20 wt. %, based on the total amount of one of components (A), (B), and (C) utilized (i.e., wt./wt.). For example, the chain-transfer agent (F) may be used in an amount of from 0.1 to 15 wt. %, such as in an amount of from 0.5 to 15, alternatively from 1 to 15, alternatively from 5 to 15 wt. %, based on the total amount of one of components (A), (B), and (C) utilized. In other embodiments, the chain-transfer agent (F) is utilized in the reaction in an amount of from 0.01 to 20 wt. % based on the total amount of components (A), (B), and (C) utilized, such as in an amount of from 0.1 to 20, alternatively from 1 to 20, alternatively from 1 to 15, alternatively from 5 to 15 wt. %, based on the total amount of components (A), (B), and (C). It will be appreciated that ratios outside of these ranges may be utilized as well, and the chain-transfer agent (F) may be utilized in one or more portions, each within one of the ranges above (e.g. such as when additional the chain-transfer agent (F) is utilized during the reaction of components (A), (B), and (C) to reach or otherwise move toward completion. It is also to be appreciated that the chain-transfer agent (F) may itself comprise more than one type of compounds suitable for acting/functioning as a chain-transfer agent, such as two, three, or more different such compounds, which may be individually or collectively utilized in an amount within one of the ranges above.

In certain embodiments, the chain-transfer agent (F) is not utilized.

In certain embodiments, the method comprises combining the silicone-acrylate copolymer and a chain terminator (G). Typically, the chain terminator (G) comprises an alkyl acrylate having the general formula H₂CCHC(O)OR², where R² is independently selected and as defined above. Typically, the chain terminator (G) is only utilized when the chain-transfer agent (F) is also utilized, and the chain terminator (G) consumes or reacts with any residual amount of the chain-transfer agent (F).

In general, reacting components (A), (B), and (C) (i.e., when utilized) comprises combining the acryloxy-functional organosilicon component (A) and the epoxy-functional acrylate component (B), and optionally the acrylate component (C), in the presence of the initiator (D) and/or other components of the reaction (e.g. the chain transfer agent (F), the solvent (E), etc.) (collectively, the “reaction components”). Said differently, there is generally no proactive step required for the reaction beyond combining the components together. As introduced above, the reaction may be generally defined or otherwise characterized as a radical polymerization reaction, and certain parameters and conditions of the reaction may be selected by those known in the art of such reactions in order to prepare the silicone-acrylate polymer.

Typically, the reaction components are reacted in a vessel or reactor to prepare the silicone-acrylate polymer. When the reaction is carried out at an elevated or reduced temperature as described below, the vessel or reactor may be heated or cooled in any suitable manner, e.g. via a jacket, mantle, exchanger, bath, coils, etc. In certain embodiments, these parameters are optimized to avoid use of the chain-transfer agent (F) while achieving silicone-acrylate polymers having the same DP or Xn achievable with the chain-transfer agent (F).

Any of the reaction components may be fed together or separately to the vessel, or may be disposed in the vessel in any order of addition, and in any combination. Typically, however, the initiator (D) will be combined with monomer-containing components (e.g. components (A), (B), and/or (C) only when the reaction is to be initiated, as will be understood by those of skill in the art. In certain embodiments, components (B) and (C) are added to a vessel containing component (A). In such embodiments, components (B) and (C) may be first combined prior to the addition, or may be added to the vessel sequentially (e.g. (C) then (B)). In certain embodiments, component (D) is added to a vessel containing components (A) and (B), either as a premade catalyst/initiator, or as individual components to form the initiator (D) in situ. In general, reference to the “reaction mixture” herein refers generally to a mixture comprising the reaction components, i.e., components (A), (B), and (D), and optionally components (C), (E), and/or (F) if utilized (e.g. as obtained by combining such components, as described above).

The reaction components can be reacted at various molar ratios, depending on the particular silicone-acrylate polymer being prepared (e.g. with respect to formula (I) above, the particular values and/or ratios of subscripts a, b, and c desired). In addition, the molar ratios between the components will depend on the active concentration of reactive molecules therein, e.g. the amount of acryloxy-functional organosilicon monomer in the acryloxy-functional organosilicon component (A), etc. As such, the molar ratios of components in the reaction will typically be selected based on the amount of reactive monomers being utilized. For example, in certain embodiments, the preparation method comprises disposing components (A) and (B) in the reaction mixture in amounts sufficient to react the acryloxy-functional organosilicon monomer and the oxiranyl acrylate ester monomer in a ratio of from 10:1 to 1:10, such as from 8:1 to 1:8, alternatively from 6:1 to 1:6, alternatively from 4:1 to 1:4, alternatively from 2:1 to 1:2, alternatively of 1:1 (A):(B). In these or other embodiments, the preparation method comprises disposing components (A) and (C) in the reaction mixture in amounts sufficient to react the acryloxy-functional organosilicon monomer and the acrylic ester monomer in a ratio of from 10:1 to 1:10, such as from 8:1 to 1:8, alternatively from 6:1 to 1:6, alternatively from 4:1 to 1:4, alternatively from 2:1 to 1:2, alternatively of 1:1 (A):(C). In these or other embodiments, the preparation method comprises disposing components (B) and (C) in the reaction mixture in amounts sufficient to react the oxiranyl acrylate ester monomer and the acrylic ester monomer in a ratio of from 10:1 to 1:10, such as from 8:1 to 1:8, alternatively from 6:1 to 1:6, alternatively from 4:1 to 1:4, alternatively from 2:1 to 1:2, alternatively of 1:1 (B):(C). However, ratios outside these ranges may also be utilized, and one of skill in the art will select the particular ratios utilized, e.g. in view of the particular silicone-acrylate polymer being prepared, the particular monomers utilized, etc. For example, when more than one acryloxy-functional organosilicon monomer is utilized, each of such monomers may be utilized in one of the ratios above.

The components of the reaction may be utilized in any form (e.g. neat (i.e., absent solvents, carrier vehicles, diluents, etc.), disposed in a carrier vehicle, etc.) and may be obtained or formed. For example, as set forth above, each compound or component may be provided “as is”, i.e., ready for the reaction to prepare the silicone-acrylate polymer. Alternatively, one or more components may be formed prior to or during the reaction. For example, in some embodiments, the method comprises preparing the acryloxy-functional organosilicon component (A), the epoxy-functional acrylate component (B), and/or the acrylate component (C).

The method may further comprise agitating the reaction mixture during and/or after formation. The agitating may enhance mixing and contacting together the reaction components when combined, e.g. in the reaction mixture thereof. Such contacting independently may use other conditions, with (e.g. concurrently or sequentially) or without (i.e., independent from, alternatively in place of) the agitating. The other conditions may be tailored to enhance the contacting, and thus reaction (i.e., polymerization), of components (A), (B), and (C) to form the silicone-acrylate polymer. Other conditions may be result-effective conditions for enhancing reaction yield or minimizing amount of a particular reaction by-product included within the reaction product along with the silicone-acrylate polymer.

In some embodiments, the reaction is carried out at an elevated temperature. The elevated temperature will be selected and controlled depending on the particular reaction components, selected, the reaction parameters employed, etc., the reaction vessel utilized (e.g. whether open to ambient pressure, sealed, under reduced pressure, etc.), etc. Accordingly, the elevated temperature will be readily selected by one of skill in the art in view of the reaction conditions and parameters selected and the description herein. The elevated temperature is typically from greater than 25° C. (ambient temperature) to 250° C., such as from 30 to 225, alternatively from 40 to 200, alternatively from 50 to 200, alternatively from 50 to 180, alternatively from 50 to 160, alternatively from 50 to 150, alternatively from 60 to 150, alternatively from 70 to 140, alternatively from 80 to 130, alternatively from 90 to 120, alternatively from 100 to 120° C. In certain embodiments, the elevated temperature is selected and/or controlled based on the boiling point of the solvent (E), such as when utilizing refluxing conditions.

It is to be appreciated that the elevated temperature may also differ from the ranges set forth above, e.g. when both elevated temperature and a reduced or elevated pressure are utilized, and other or alternative reaction conditions may be employed. For example, in certain embodiments, a reduced or elevated pressure is utilized in order to maintain reaction progression while utilizing a lower reaction temperature, which may lead to a decrease in the formation of undesirable byproducts (e.g. degradation, and/or decomposition byproducts). Likewise, it is also to be appreciated that reaction parameters may be modified during the reaction of the reaction components. For example, temperature, pressure, and other parameters may be independently selected or modified during the reaction. Any of these parameters may independently be an ambient parameter (e.g. room temperature and/or atmospheric pressure) and/or a non-ambient parameter (e.g. reduced or elevated temperature and/or reduced or elevated pressure). Any parameter, may also be dynamically modified, modified in real time, i.e., during the method, or may be static (e.g. for the duration of the reaction, or for any portion thereof). Oxygen may optionally be removed from the reaction during the preparation method, e.g. by bubbling nitrogen or another inert gas into the vessel.

The time during which the reaction to prepare the silicone-acrylate polymer is carried out is a function of scale, reaction parameters and conditions utilized, the reaction components selected, etc. On a relatively large scale (e.g. greater than 1, alternatively 5, alternatively 10, alternatively 50, alternatively 100 kg), the reaction may be carried out for hours, such as from 2 to 240, alternatively from 2 to 120, alternatively from 2 to 96, alternatively from 2 to 72, alternatively from 2 to 48, alternatively from 2 to 36, alternatively from 2 to 24, alternatively from 2 to 12, alternatively for a duration of 3, 4, 5, 6, 12, 18, 24, 36, or 48 hours, as will be readily determined by one of skill in the art (e.g. by monitoring conversion of components (A), (B), and/or (C), production of the silicone-acrylate polymer, etc., such as via chromatographic and/or spectroscopic methods). In certain embodiments, the time during which the reaction is carried out is from greater than 0 to 240 hours, alternatively from 1 to 120 hours, alternatively from 1 to 96 hours, alternatively from 1 to 72 hours, alternatively from 1 to 48 hours, alternatively from 1 to 36 hours, alternatively from 1 to 24 hours, alternatively from 1 to 12 hours, alternatively from 2 to 12 hours, alternatively from 2 to 8 hours, after the reaction components are combined.

Generally, the reaction of components (A), (B), and (C) prepares a reaction product comprising the silicone-acrylate polymer. In particular, over the course of the reaction, the reaction mixture comprises increasing amounts of the silicone-acrylate polymer being prepared and decreasing amounts of the monomers of components (A), (B), and (C) utilized in the reaction. Once the reaction is complete (e.g. one or more of components (A), (B), and (C) is consumed, no additional silicone-acrylate polymer is being prepared, etc.), the reaction mixture may be referred to as the reaction product comprising the silicone-acrylate polymer. In this fashion, the reaction product typically includes any remaining amounts of the reaction components, as well as degradation and/or reaction products thereof. If the reaction is carried out in any carrier vehicle or solvent (e.g. solvent (E)), the reaction product may also include such carrier vehicle or solvent.

In certain embodiments, the method further comprises isolating and/or purifying the silicone-acrylate polymer from the reaction product. As used herein, isolating the silicone-acrylate polymer is typically defined as increasing the relative concentration of the silicone-acrylate polymer as compared to other compounds in combination therewith (e.g. in the reaction product or a purified version thereof). As such, as is understood in the art, isolating/purifying may comprise removing the other compounds from such a combination (i.e., decreasing the amount of impurities combined with the silicone-acrylate polymer, e.g. in the reaction product) and/or removing the silicone-acrylate polymer itself from the combination. Any suitable technique and/or protocol for isolation may be utilized. Examples of suitable isolation techniques include distilling, stripping/evaporating, extracting, filtering, washing, partitioning, phase separating, chromatography, and the like. As will be understood by those of skill in the art, any of these techniques may be used in combination (i.e., sequentially) with any another technique to isolate the silicone-acrylate polymer. It is to be appreciated that isolating may include, and thus may be referred to as, purifying the silicone-acrylate polymer. However, purifying the silicone-acrylate polymer may comprise alternative and/or additional techniques as compared to those utilized in isolating the silicone-acrylate polymer. Regardless of the particular technique(s) selected, isolation and/or purification of silicone-acrylate polymer may be performed in sequence (i.e., in line) with the reaction itself, and thus may be automated. In other instances, purification may be a stand-alone procedure to which the reaction product comprising the silicone-acrylate polymer is subjected.

The silicone-acrylate polymer prepared via the preparation method is the reaction product the reaction components utilized (e.g. each acryloxy-functional organosilicon monomer of component (A), each oxiranyl acrylate ester monomer of component (B), each acrylic ester monomer of component (C), each radical-polymerization active compound of component (D), and each thiol compound or the like of component (F), when such components are utilized). As such, it is to be appreciated that many variations and particular species of the silicone-acrylate polymer may be prepared, e.g. depending on the particular reaction components selected and reaction conditions employed. However, the silicone-acrylate polymer prepared by the preparation method corresponds to the general average unit formula (I) set forth above.

In certain embodiments, the liquid composition further comprises one or more additional components, such as one or more additives (e.g. agents, adjuvants, ingredients, modifiers, auxiliary components, etc.) aside from components (I) and (II).

It is to be appreciated that additives suitable for use in the liquid composition may be classified under numerous and different terms of art, and just because an additive is classified under such a term does not mean that it is thusly limited to that function. Moreover, some of additives may be present in a particular component of the liquid composition (e.g. when a multi-component composition), or instead may be incorporated when forming the liquid composition.

Typically, the liquid composition may comprise any number of additives, e.g. depending on the particular type and/or function of the same in the liquid composition. For example, in certain embodiments, the liquid composition may comprise one or more additives comprising, alternatively consisting essentially of, alternatively consisting of: a filler; a filler treating agent; a surface modifier; a surfactant; a rheology modifier; a viscosity modifier; a binder; a thickener; a tackifying agent; an adhesion promotor; a defoamer; a compatibilizer; an extender; a plasticizer; an end-blocker; a reaction inhibitor; a drying agent; a water release agent; a colorant (e.g. a pigment, dye, etc.); an anti-aging additive; a biocide; a flame retardant; a corrosion inhibitor; a catalyst inhibitor; a UV absorber; an anti-oxidant; a light-stabilizer; a catalyst (e.g. other than the catalyst (C)), procatalyst, or catalyst generator; an initiator (e.g. a heat activated initiator, an electromagnetically activated initiator, etc.); a photoacid generator; a heat stabilizer; and the like, as well as derivatives, modifications, and combinations thereof.

The one or more of the additives can be present as any suitable weight percent (wt. %) of the liquid composition, such as in an amount of from 0.01 wt. % to 65 wt. %, such as from 0.05 to 35, alternatively from 0.1 to 15, alternatively from 0.5 to 5 wt. %. In these or other embodiments, one or more of the additives can be present in the liquid composition in an amount of 0.1 wt. % or less, alternatively of 1, 2, 3, 4, 5, 6, 7, 8, 9, 10, 11, 12, 13, 14, or 15 wt. %, or more of the liquid composition. One of skill in the art can readily determine a suitable amount of a particular additive depending, for example, on the type of additive and the desired outcome.

In certain embodiments, the liquid composition is substantially free from, alternatively is free from, a reaction catalyst or promotor (e.g. with respect to the cross-linking reaction of components (I) and (II)), other than components (I) and (II). In these or other embodiments, the liquid composition is substantially free from, alternatively is free from, a carrier vehicle, i.e., other than components (I) and (II) (e.g. when one or both of the components (I) and (II) is capable of acting as a carrier vehicle).

In certain embodiments, the liquid composition is further defined as (i) a solvent-borne composition; (ii) an aqueous composition; (iii) an oil composition; (iv) a film-forming composition; (v) a curable composition; (vi) a coating composition; (vii) a paint composition; (viii) a surface treating composition; or (ix) an adhesive composition. As understood in the art, such end use compositions may include further optional components. For example, when the liquid composition is a curable composition, a curing agent and/or catalyst are typically included in or combined with the liquid composition. One of skill in the art knows how to formulate such end use compositions with the inventive liquid composition, including based on any functionalization of the silicone-acrylate polymer.

The liquid composition may be used for example to prepare films or coatings. For example, the liquid composition can be least one of a film-forming agent, a surface treating agent, an additive for coatings, an additive for paints, or an additive for adhesives.

It is to be understood that, although a polymer is often referred to as comprising or being “made of” or one or more specified monomerics, “based on,” “formed from,” or “derived from” a specified monomer or monomer type, “containing” a specified monomer content or proportion of a specified monomer, in this context the term “monomer” is understood to be referring to the monomeric unit in the polymer itself, i.e., the polymerized remnant of the specified monomer utilized in preparing the polymer, or a unit that could be so prepared, and not to the unpolymerized monomer species. As such, as used herein, polymers are generally referred to has having monomeric units in the polymerized form, which each correspond to an unpolymerized monomer (i.e., even if such monomer was not used to prepare the particular monomeric unit denoted, such as when an oligomer is utilized to prepare the specifies polymer).

In any of the polymers described above, it is also to be understood that that trace amounts of impurities can be incorporated into or otherwise present in the polymer structure without changing the characterization of the polymer itself, which will generally be classified based on an average monomeric unit formula (i.e., excluding trace amounts of impurities from, for example, catalyst residues, initiators, terminators, etc., which may be incorporated into and/or within the polymer).

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

The following examples, illustrating embodiments of this disclosure, are intended to illustrate and not to limit the invention. Unless otherwise noted, all reactions are carried out under air, and all solvents, substrates, and reagents are purchased or otherwise obtained from various commercial suppliers.

The following equipment and characterization procedures/parameters are used to evaluate various physical properties of the compounds and compositions prepared in the examples below. In all of the examples below, the resulting silicone-acrylate polymers were liquids at room temperature, even in the absence of any organic solvent or carrier vehicle.

### Nuclear Magnetic Resonance Spectroscopy (NMR)

Nuclear magnetic resonance (NMR) analysis is conducted on a Varian Unity INOVA 400 (400 MHz) spectrometer, using a silicon-free 10 mm tube and appropriate solvent (e.g. CDCl₃). Chemical shifts for spectra are referenced to internal protio solvent resonance (¹H:CDCl₃; ²⁹Si:tetramethylsilane).

### Gel Permeation Chromatography (GPC)

Gel permeation chromatography (GPC) analysis is conducted on an Agilent 1260 Infinity II chromatograph with an Agilent refractive index detector using GPC/SEC software and equipped with PLgel 5 μm Mixed-C columns (300×7.5 mm; Polymer Laboratories) preceded by a PLgel 5 μm guard column. Analysis is performed using tetrahydrofuran (THF) mobile phase at a nominal flow rate of 1.0 mL/min at 35° C., with samples dissolved in THF (5 mg/mL), and optionally filtered through a 0.2 μm PTFE syringe filter, prior to injection. Calibration is performed using narrow polystyrene (PS) standards covering the range of 580 to 2,300,000 g/mol fit to a 3rd order polynomial curve.

### Dynamic Viscosity (DV)

Viscosity measurements are performed on an Anton-Paar Physica MCR 301 rheometer fitted with a 50 mm stainless steel cone-in-plate fixture (CP 25, 1.988″ cone angle with 104 μM truncation) at an operating temperature of 25° C. using the Expert flow curve steady state control method available in the accompanying software package (Rheoplus 32 V3.40). A shear rate sweep from 0.1 to 500 s⁻¹ is performed and values at a frequency of 10 rad/sec are reported in centipoise (cP).

### Glass Transition Temperature (Tg)

Glass transition temperatures are measured via differential scanning calorimetry based DSC Q2000 V24.10 in accordance with ASTM D⁷⁴²⁶ with a sample size of about 5-10 mg on the second heating cycle.

The various components utilized in the Examples are set forth in Table 1 below.

TABLE 1
Components/Compounds Utilized

| Component | Description |
|---|---|
| Organosilicon Monomer (A1) | [bis(trimethylsiloxy)methylsiloxy]-propyl methacrylate, i.e., a |
| | (meth)acryloxy-functional organosilicon compound (monomer) |
| | having formula: |
| | 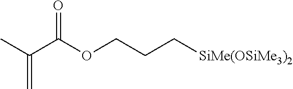 |
| Organosilicon Monomer (A2) | Mono-(meth)acrylate-terminated polydimethylsiloxane having |
| | a MW = 800-1000), i.e., a (meth)acryloxy-functional |
| | organosilicon compound (monomer) having general formula: |
| | 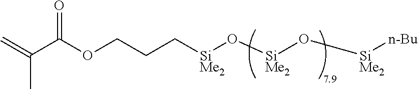 |
| Epoxy-functional Acrylate | Glycidyl methacrylate (GMA) |
| Monomer (B1) | |
| Acrylate Monomer (C1) | n-butyl (meth)acrylate (BMA) |
| Acrylate Monomer (C2) | 2-ethylhexyl (meth)acrylate (EHMA) |
| Initiator (D1) | tert-butyl peroxypivalate (tBPPiv) |
| Initiator (D2) | Benzoyl peroxide (BPO) |
| Chain Transfer Agent (F1) | Thiol-functional organosilicon compound of formula: |
| | (H₃CO)₂(H₃C)Si(CH₂)₃SH |
| Chain Terminator (G1) | n-butyl acrylate (BA) |
| Solvent (E) | Toluene |

### Examples 1-6 and Comparative Examples 1-2

### General Procedure 1: Preparation of Silicone-Acrylate Polymers

Examples 1-6 and Comparative Examples 1-2 follow General Procedure 1. In particular, Solvent (E) (80 g) is added to an oven-dried 500 mL 4-neck round bottomed flask, equipped with stir shaft, condenser, thermocouple port, addition ports, and a heating mantle. The contents of the flask are heated to 85° C. Then, a Monomer Blend as set forth in Table 2 below is prepared and split into two plastic syringes (except for Example 6, which utilizes only one plastic syringe) with Luer Lock connectors, which are equipped with a feed line into the flask and connected to a syringe pump. The Monomer Blend is fed at a rate of 7.267 g/min. Five minutes after starting feed of Monomer Blend into the flask, a mixture of Initiator (D1) (11 g) and Solvent (E) (20 g) (the “initiator blend”) is added to another plastic syringe with a Luer Lock connector, which is equipped with a feed line into the flask and connected to a syringe pump. The initiator blend is fed at a rate of 0.148 mL/min. The Monomer Blend is fed for one hour, and the initiator blend is fed for two hours. 30 minutes after ceasing feed of the Monomer Blend, 4 grams of Chain Terminator (G1) are disposed in the flask. The flask is heated for 80 minutes after ceasing feed of the initiator blend. The reaction monitored via ¹H NMR. In Table 2 below, the amounts of the components in each Monomer Blend are in grams, and C.E. designates Comparative Example.

TABLE 2
Monomer Blend

| Example: | (A1) | (C1) | (C2) | (F1) | (E) |
|---|---|---|---|---|---|
| 1 | 80 | 320 | 0 | 36 | 5 |
| 2 | 200 | 200 | 0 | 36 | 5 |
| 3 | 40 | 0 | 360 | 36 | 5 |
| 4 | 80 | 0 | 320 | 36 | 5 |
| 5 | 200 | 0 | 200 | 36 | 5 |
| 6 | 400 | 0 | 0 | 36 | 5 |
| C.E. 1 | 0 | 0 | 400 | 36 | 5 |
| C.E. 2 | 0 | 400 | 0 | 36 | 5 |

### Properties of Examples 1-6 and Comparative Examples 1-2

The silicone-acrylate polymers of Examples 1-6 were targeted to have a number average molecular weight of 2,000 Da. The number average degree of polymerization (Xn) varies based on the monomers (A1), (C1), and (C2) utilized given their different molecular weights. Table 3 below shows the physical properties of the silicone-acrylate polymers of Examples 1-6 and Comparative Examples 1-2 measured as described above.

TABLE 3
Physical Properties

| | | Mn | | | Viscosity | Viscosity | |
|---|---|---|---|---|---|---|---|
| | Xn | Target | Mn/Mw | Solids | (cP at γ = | (cP at γ = | Tg |
| Example: | Target | (kDa) | (kDa) | (%) | 50 s⁻¹) | 500 s⁻¹) | (° C.) |
| 1 | 12.4 | 2.0 | 2.2/3.6 | 81.3 | 994 | 1013 | −33 |
| 2 | 9.9 | 2.0 | 2.3/3.5 | 78.5 | 144 | 145 | −48 |
| 3 | 10.1 | 2.0 | 1.8/2.9 | 79.8 | 500 | 492 | −50 |
| 4 | 9.7 | 2.0 | 1.9/3.0 | 79.8 | 479 | 462 | −52 |
| 5 | 9.2 | 2.0 | 1.9/3.1 | 80.0 | 367 | 365 | −48 |
| 6 | 7.9 | 2.0 | 1.9/3.0 | 79.7 | 157 | 158 | −58 |
| C.E. 1 | 14.1 | 2.0 | 2.1/3.5 | 80.1 | 2377 | 2232 | −21 |
| C.E. 2 | 10.1 | 2.0 | 1.8/2.9 | 79.8 | 500 | 492 | −50 |

### Examples 7-12 and Comparative Examples 3-4

### General Procedure 2: Preparation of Silicone-Acrylate Polymers

Examples 7-12 and Comparative Examples 3-4 follow General Procedure 2. In particular, Solvent (E) (80 g) is added to an oven-dried 500 mL 4-neck round bottomed flask, equipped with stir shaft, condenser, thermocouple port, addition ports, and a heating mantle. The contents of the flask are heated to 85° C. Then, a Monomer Blend as set forth in Table 4 below is prepared and split into two plastic syringes (except for Example 12, which utilizes only one plastic syringe) with Luer Lock connectors, which are equipped with a feed line into the flask and connected to a syringe pump. The Monomer Blend is fed at a rate of 7.145 g/min. Five minutes after starting feed of Monomer Blend into the flask, a mixture of Initiator (D1) (11 g) and Solvent (E) (20 g) (the “initiator blend”) is added to another plastic syringe with a Luer Lock connector, which is equipped with a feed line into the flask and connected to a syringe pump. The initiator blend is fed at a rate of 0.148 mL/min. The Monomer Blend is fed for one hour, and the initiator blend is fed for two hours. 30 minutes after ceasing feed of the Monomer Blend, 4 grams of Chain Terminator (G1) are disposed in the flask. The flask is heated for 80 minutes after ceasing feed of the initiator blend. The reaction monitored via ¹H NMR. In Table 4 below, the amounts of the components in each Monomer Blend are in grams, and C.E. designates Comparative Example.

TABLE 4
Monomer Blend

| Example: | (A1) | (C1) | (C2) | (F1) | (E) |
|---|---|---|---|---|---|
| 7 | 80 | 320 | 0 | 28.7 | 5 |
| 8 | 200 | 200 | 0 | 28.7 | 5 |
| 9 | 40 | 0 | 360 | 28.7 | 5 |
| 10 | 80 | 0 | 320 | 28.7 | 5 |
| 11 | 200 | 0 | 200 | 28.7 | 5 |
| 12 | 400 | 0 | 0 | 28.7 | 5 |
| C.E. 3 | 0 | 0 | 400 | 28.7 | 5 |
| C.E. 4 | 0 | 400 | 0 | 28.7 | 5 |

### Properties of Examples 7-12 and Comparative Examples 3-4

The silicone-acrylate polymers of Examples 7-12 were targeted to have a number average degree of polymerization (Xn) of 12.4. The number average molecular weight (Mn) varies based on the monomers (A1), (C1), and (C2) utilized given their different molecular weights in connection with Xn. Table 5 below shows the physical properties of the silicone-acrylate polymers of Examples 7-12 and Comparative Examples 3-4 measured as described above.

TABLE 5
Physical Properties

| | | Mn | | | Viscosity | Viscosity | |
|---|---|---|---|---|---|---|---|
| | Xn | Target | Mn/Mw | Solids | (cP at γ = | (cP at γ = | Tg |
| Example: | Target | (kDa) | (kDa) | (%) | 50 s⁻¹) | 500 s⁻¹) | (° C.) |
| 7 | 12.4 | 2.0 | 2.2/3.6 | 81.3 | 994 | 1013 | −33 |
| 8 | 12.4 | 2.5 | 2.2/3.8 | 79.2 | 352 | 356 | −42 |
| 9 | 12.4 | 2.6 | 2.2/3.8 | 80.1 | 748 | 719 | −45 |
| 10 | 12.4 | 2.7 | 2.2/3.9 | 80.0 | 592 | 560 | −42 |
| 11 | 12.4 | 3.2 | 2.5/4.4 | 78.9 | 323 | 323 | −50 |
| 12 | 12.4 | 4.3 | 2.9/5.4 | 77.1 | 96 | 97 | −55 |
| C.E. 3 | 12.4 | 1.7 | 1.8/3.0 | 80.2 | 1844 | 1705 | −27 |
| C.E. 4 | 12.4 | 2.5 | 2.2/3.6 | 79.8 | 769 | 733 | −43 |

### Examples 13-17 and Comparative Example 5

### General Procedure 3: Preparation of Silicone-Acrylate Polymers

Examples 13-17 and Comparative Example 5 follow General Procedure 3. General Procedure 3 is specific to Example 13, and Examples 14-17 and Comparative Example 5 modify the molar ratios of components utilized in the monomer blend as defined below and set forth in Table 6. In particular, in Example 13 and General Procedure 3, Solvent (E) (10 g) is added to an oven-dried 500 mL 4-neck round bottomed flask, equipped with stir shaft, condenser, thermocouple port, addition ports, and a heating mantle. A mixture of Organosilicon Monomer (A1) (45 g), Organosilicon Monomer (A2) (47 g), Epoxy-functional. Acrylate Monomer (B1) (11 g), and Chain Transfer Agent (F1) (5 g) (collectively, the “monomer blend”) is prepared in a plastic syringes with a Luer Lock connector, which are equipped with a feed line into the flask and connected to a syringe pump. A mixture of Initiator (D2) (3.15 g) and Solvent (E) (30 g) (the “initiator blend”) is added to another plastic syringe with a Luer Lock connector, which is equipped with a feed line into the flask and connected to a syringe pump. The flask is heated to reach a target temperature (110° C.) with stirring, at which time a feed of the monomer blend is initiated (rate: 2 g/min; duration: 54 min). After a 5 min delay, a feed of the initiator blend is initiated (duration: 150 min), and the reaction monitored via 1H NMR. After completion of both feeds, the reaction mixture is maintained at the target temperature (110° C.) with stirring for 1 h, and then allowed to cool to room temperature (˜23° C.) to give a reaction product comprising an epoxide-functional silicone-acrylate polymer. The reaction product is stripped of solvent in vacuo to isolate the epoxide-functional silicone-acrylate polymer, which is then characterized according to the procedures above.

As noted above, the molar ratios of Components (A1), (A2), and (B1) are modified in Examples 14-17 and Comparative Example 5 beyond the specific values utilized above in Example 13 and General Procedure 3. The molar ratios are set forth below in Table 6 for Examples 13-17 and Comparative Example 5. Values in Table 6 are mole fractions based on the total amount of monomer blend utilized in each Example.

TABLE 6

| Example | (A1) | (A2) | (B1) | (C1) |
|---|---|---|---|---|
| 13 | 0.5 | 0.2 | 0.3 | 0 |
| 14 | 0.7 | 0 | 0.3 | 0 |
| 15 | 0.6 | 0 | 0.4 | 0 |
| 16 | 0.5 | 0 | 0.5 | 0 |
| 17 | 0.5 | 0 | 0.5 | 0 |
| C.E. 5 | 0 | 0 | 0.28 | 0.72 |

### Properties of Examples 13-17 and Comparative Example 5

The number-average molecular weight, polydispersity, and viscosity of the silicone-acrylate copolymers of Examples 13-17 and Comparative Example 5 are measured as described above and set forth below in Table 7.

TABLE 7
Physical Properties

| | Mn | | Viscosity (cP |
|---|---|---|---|
| Example: | (Da) | PD | at 25° C.) |
| 13 | 8156 | 1.6 | 750 |
| 14 | 3741 | 1.46 | 11822 |
| 15 | 2920 | 1.42 | 11528 |
| 16 | 2847 | 1.44 | 36275 |
| 17 | 9260 | 2.03 | 1105 |
| C.E. 5 | 1815 | 1.71 | 22048 |

1. A liquid composition, comprising:
a silicone-acrylate polymer having the following average unit formula: 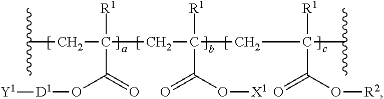
where each R¹ is independently H or CH₃; each R² is independently H or a substituted or unsubstituted hydrocarbyl group; X¹ is an independently selected epoxide-functional moiety; each D¹ is a divalent linking group; each Y¹ is an independently selected siloxane moiety; a≥1, b≥0, and c≥0, with the proviso that a+b+c≥2; wherein moieties indicated by subscripts a, b, and c may be in any order in the silicone-acrylate polymer; and
optionally, a carrier vehicle;
wherein the liquid composition comprises a total amount of organic solvent in a range of from 0-25 wt. % based on the total weight of the liquid composition; and
wherein the silicone-acrylate polymer has a number-average molecular weight (Mn) of from 500 to 5000 Da.

2. The liquid composition of claim 1, wherein the silicone-acrylate polymer comprises: (i) a dynamic viscosity of less than 1,000 centipoise (cP) at 25° C.; (ii) a mass dispersity (Dm) of from 1.1 to 10; or (iii) both (i) and (ii).

3. The liquid composition of claim 1, wherein the silicone-acrylate polymer comprises: (i) a number-average degree of polymerization (Xn) of from 2 to 35; (ii) a glass transition temperature (Tg) of from −20° C. to −60° C.; or (iii) both (i) and (ii).

4. The liquid composition of claim 1, wherein in the silicone-acrylate polymer: (i) each R¹ is CH₃; (ii) each R² is an independently selected unsubstituted hydrocarbyl group having from 1 to 10 carbon atoms; (iii) subscript a is from 1 to 25; (iv) subscript b is from 0 to 25; (v) subscript c is from 1 to 25; or (vi) any combination of (i)-(v).

5. The liquid composition of claim 1, wherein in the silicone-acrylate polymer: (i) each R¹ is CH₃ and each R² is independently selected from methyl, ethyl, butyl, hexyl, and octyl groups; (ii) at least one siloxane moiety Y¹ comprises a siloxane group having the following general formula: 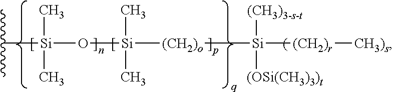
where 0≤n≤100, subscript o is from 2 to 6, subscript p is 0 or 1, subscript q is 0 or 1, subscript r is from 0 to 9, subscript s is 0 or 1, and subscript t is 0 or 2, with the provisos that subscript t is 0 when subscript s is 1, and subscript t is 2 when subscript s is 0; or (iii) both (i) and (ii).

6. The liquid composition of claim 1, comprising the carrier vehicle in an amount of from greater than 0 to 25 wt. %, based on the total amount of the silicone-acrylate polymer present in the liquid composition, wherein the carrier vehicle is non-aqueous.

7. A method of preparing the liquid composition of claim 1, said method comprising combining the silicone-acrylate polymer and optionally the carrier vehicle to give the liquid composition.

8. The method of claim 7, further comprising preparing the silicone-acrylate polymer by reacting (A) an acryloxy-functional organosilicon compound, optionally (B) an epoxy-functional acrylate component; and optionally (C) an acrylate component, to give the silicone-acrylate polymer;
wherein the acryloxy-functional organosilicon component (A) comprises an acryloxy-functional organosilicon monomer having the general formula: 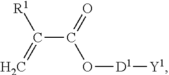
the optional epoxy-functional acrylate component (B) comprises an oxiranyl acrylate ester monomer having the general formula: 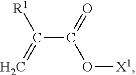
and the optional acrylate component (C) comprises an acrylic ester monomer having the general formula: 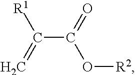
where each R¹, R², D¹, Y¹, and X¹ is independently selected and as defined above.

9. The method of claim 8, wherein the acrylate component (C) is utilized and comprises at least two acrylate monomers each corresponding to the general formula above and different from one another with respect to at least one of R¹ and R².

10. The method of claim 8, wherein the acrylate component (C) is utilized, and wherein, in the acrylate monomer: (i) R¹ is CH₃; (ii) R² is an independently selected unsubstituted hydrocarbyl group having from 1 to 10 carbon atoms; or (iii) both (i) and (ii).

11. The method of claim 8, wherein the acryloxy-functional organosilicon compound (A), optionally the epoxy-functional acrylate component (B), and optionally the acrylate component (C) are reacted in the presence of: (D) an initiator; (E) a solvent; (F) a chain-transfer agent; or any combination of components (D)-(F).

12. The method of claim 11, wherein the acryloxy-functional organosilicon compound (A), optionally the epoxy-functional acrylate component (B), and optionally the acrylate component (C) are reacted in the presence of the initiator (D), and wherein the initiator (D) is further defined as a free-radical initiator.

13. The method of claim 9, wherein the acryloxy-functional organosilicon compound (A), optionally the epoxy-functional acrylate component (B), and optionally the acrylate component (C) are reacted in the presence of (F) a chain-transfer agent, and wherein the chain-transfer agent (F) comprises a thiol compound having the general formula Y—SH, where Y is selected from substituted and unsubstituted hydrocarbon moieties, organosilicon moieties, and combinations thereof.

14. The method of claim 13, wherein in the thiol compound of the chain-transfer agent (F): (i) Y comprises a substituted or unsubstituted hydrocarbyl group having from 6 to 12 carbon atoms; (ii) Y comprises an alkylene group having from 2 to 11 carbon atoms; (iii) Y comprises an alkoxysilane group having the formula —Si(OR³)_{c}(R³)_{3-c}, where each R³ is an independently selected unsubstituted hydrocarbyl group having from 1 to 6 carbon atoms and subscript c is 1, 2, or 3; or (iv) any combination of (i)-(iii).

15. The method of claim 13, wherein the chain-transfer agent (F) comprises: (H₃CO)₂(H₃C)Si(CH₂)₃SH; (ii) dodecane thiol; or (iii) both (i) and (ii).

16. The method of claim 9, wherein the method further comprises combining the silicone-acrylate copolymer and (G) a chain terminator, and wherein the chain terminator (G) comprises an alkyl acrylate having the general formula H₂CCHC(O)OR², where R² is independently selected and as defined above.

17. The liquid composition of claim 1, further defined as at least one of: (i) a solvent-borne composition; (ii) an aqueous composition; (iii) an oil composition; (iv) a film-forming composition; (v) a curable composition; (vi) a coating composition; (vii) a paint composition; (viii) a surface treating composition; or (ix) an adhesive composition.

18. A film formed with the liquid composition of claim 1.

19. (canceled)
